(19) United States
(12) Patent Application Publication
(10) Pub. No.: US 2013/0170542 A1
(43) Pub. Date: Jul. 4, 2013

(54) IMAGE PROCESSING DEVICE AND METHOD

(71) Applicant: Kazushi Sato, Kanagawa (JP)

(72) Inventor: Kazushi Sato, Kanagawa (JP)

(73) Assignee: SONY CORPORATION, Tokyo (JP)

(21) Appl. No.: 13/822,049

(22) PCT Filed: Oct. 5, 2011
(86) PCT No.: PCT/JP11/72953

§ 371 Date: Mar. 11, 2013

(30) Foreign Application Priority Data
Oct. 14, 2010 (JP) 2010-231591

(51) Int. Cl. H04N 7/26

(52) U.S. Cl. CPC H04N 19/00066
USPC 375/240.02

(57) ABSTRACT

This disclosure relates to an image processing device and method for reducing the load of image encoding, and a program. This technique involves: a filter control unit that controls an adaptive filtering operation to be performed on image data, in accordance with whether the image data is to be referred to by other image data; and a filtering operation unit that performs the adaptive filtering operation on the image data under the control of the filter control unit in a motion compensation loop. This technique can be applied to an image processing device, for example.

### TECHNICAL FIELD

This disclosure relates to an image processing device and method, and more particularly, to an image processing device that can reduce the load of image encoding.

### BACKGROUND ART

In recent years, to handle image information as digital information and achieve high-efficiency information transmission and accumulation in doing do, apparatuses compliant with a standard, such as MPEG (Moving Picture Experts Group) for compressing image information through orthogonal transforms such as discrete cosine transforms and motion compensations by using redundancy inherent to image information, have been spreading among broadcast stations to distribute information and among general households to receive information.

Particularly, MPEG2 (ISO (International Organization for Standardization)/IEC (International Electrotechnical Commission) 13818-2) is defined as a general-purpose image encoding standard, and is applicable to interlaced images and non-interlaced images, and to standard-resolution images and high-definition images. Currently, MPEG2 is used in a wide range of applications for professionals and general consumers. According to the MPEG2 compression standard, a bit rate of 4 to 8 Mbps is assigned to an interlaced image having a standard resolution of 720×480 pixels, and a bit rate of 18 to 22 Mbps is assigned to an interlaced image having a high resolution of 1920×1088 pixels, for example. In this manner, high compression rates and excellent image quality can be realized.

MPEG2 is designed mainly for high-quality image encoding suited for broadcasting, but is not compatible with lower bit rates than MPEG1 or encoding standards with higher compression rates. As mobile terminals are becoming popular, the demand for such encoding standards is expected to increase in the future, and to meet the demand, the MPEG4 encoding standard has been set. As for image encoding standards, the ISO/IEC 14496-2 standard was approved as an international standard in December 1998.

Further, a standard called H.26L (ITU-T (International Telecommunication Union Telecommunication Standardization Sector) Q6/16 VCEG (Video Coding Expert Group)), which is originally intended for encoding images for video conferences, is currently being set. Compared with the conventional encoding methods such as MPEG2 and MPEG4, H.26L requires a larger amount of calculation in encoding and decoding, but is known to achieve a higher encoding efficiency. Also, as a part of the MPEG4 activity, “Joint Model of Enhanced-Compression Video Coding” is now being established as a standard for achieving a higher encoding efficiency by incorporating functions unsupported by H.26L into the functions based on H.26L.

On the standardization schedule, the standard was approved as an international standard under the name of H.264 and MPEG-4 Part 10 (Advanced Video Coding, hereinafter referred to as AVC) in March 2003.

Further, as an extension of that, FRExt (Fidelity Range Extension) involving encoding tools required for professional use, such as RGB, 4:2:2, and 4:4:4, and 8×8 DCT and quantization matrixes specified in MPEG2, was set as a standard in February 2005. This is an encoding method for enabling excellent representation of even film noise contained in movie films by using AVC, and is now used in a wide range of applications such as Blu-Ray discs.

However, there is an increasing demand for encoding at a higher compression rate so as to compress images having a resolution of 4096×2048 pixels, which is four times higher than the high-definition image resolution, or distribute high-definition images in today's circumstances where transmission capacities are limited as in the Internet. Therefore, studies on improvement in encoding efficiency are still continued by VCEG under ITU-T.

When images having an even higher resolution, such as 4000×2000 pixels, or existing high-definition images are transmitted through a line with a limited bandwidth such as the Internet, a compression rate achieved by AVC is not sufficiently high. In view of this, a group called VCEG (Video Coding Expert Group) under ITU-T is trying to further improve encoding efficiency (see Non-Patent Document 1, for example).

As a method for improving encoding efficiency, Non-Patent Document 1 suggests a method involving an adaptive loop filter (ALF).

### CITATION LIST

### Non-Patent Document

Non-Patent Document 1: Takeshi. Chujoh, et al., “Block-based Adaptive Loop Filter” ITU-T SG16 Q6 VCEG Contribution, AI18, Germany, July, 2008

### SUMMARY OF THE INVENTION

### Problems to be Solved by the Invention

However, using the adaptive loop filter suggested in Non-Patent Document 1 for all the pictures and slices in the sequence requires an enormous amount of calculation, and there is a possibility of an increase in the image encoding operation load.

This disclosure has been made in view of those circumstances, and an object thereof is to reduce the load of the adaptive loop filter while restraining increases in image quality deterioration, so as to restrain increases in the image encoding operation load caused by the adaptive loop filtering operation.

### Solutions to Problems

An aspect of this disclosure is an image processing device that includes: a filter control unit that controls an adaptive filtering operation to be performed on image data, in accordance with whether the image data is to be referred to by other image data; and a filtering operation unit that performs the adaptive filtering operation on the image data under the control of the filter control unit in a motion compensation loop.

When the image data being subjected to the adaptive filtering operation is to be referred to by the other image data in an operation to encode the image data, the filter control unit can control the adaptive filtering operation to be performed. When the image data being subjected to the adaptive filtering operation is not to be referred to by the other image data in the operation to encode the image data, the filter control unit can control the adaptive filtering operation not to be performed.

The image data may be picture data, and the filter control unit can control the adaptive filtering operation for the image data in accordance with the type of the picture.

When the image data is an I-picture, the filter control unit can control the adaptive filtering operation to be performed. When the image data is a P-picture and a B-picture, the filter control unit can control the adaptive filtering operation not to be performed.

When the image data is an I-picture or a P-picture, the filter control unit can control the adaptive filtering operation to be performed. When the image data is a B-picture, the filter control unit can control the adaptive filtering operation not to be performed.

When the image data is an I-picture and a P-picture in image data containing hierarchical B-pictures, or a B-picture to be referred to, the filter control unit can control the adaptive filtering operation to be performed. When the image data is a B-picture not to be referred to in the image data containing hierarchical B-pictures, the filter control unit can control the adaptive filtering operation not to be performed.

The image data may be slice data, and the filter control unit can control the adaptive filtering operation for the image data in accordance with the type of the slice.

When the image data is an I-slice, the filter control unit can control the adaptive filtering operation to be performed. When the image data is a P-slice and a B-slice, the filter control unit can control the adaptive filtering operation not to be performed.

When the image data is an I-slice or a P-slice, the filter control unit can control the adaptive filtering operation to be performed. When the image data is a B-picture, the filter control unit can control the adaptive filtering operation not to be performed.

When the image data is an I-slice and a P-slice in image data containing hierarchical B-slices, or a B-slice to be referred to, the filter control unit can control the adaptive filtering operation to be performed. When the image data is a B-slice not to be referred to in the image data containing hierarchical B-pictures, the filter control unit can control the adaptive filtering operation not to be performed.

The image processing device further includes an encoding unit that encodes the image data subjected to the adaptive filtering operation. The encoding unit can encode the filter coefficient of the adaptive filtering operation and flag information indicating whether to perform the adaptive filtering operation, and adds the resultant data to the encoded data of the image data.

The filter control unit can control the tap length of the filter coefficient of the adaptive filtering operation, in accordance with whether the image data is to be referred to by other image data. The filtering operation unit can perform the adaptive filtering operation on the image data, using the filter coefficient having the tap length controlled by the filter control unit.

When the image data being subjected to the adaptive filtering operation is to be referred to by the other image data in an operation to encode the image data, the filter control unit can perform control to increase the tap length. When the image data being subjected to the adaptive filtering operation is not to be referred to by the other image data in the operation to encode the image data, the filter control unit can perform control to shorten the tap length.

An aspect of this disclosure is an image processing method that includes: controlling an adaptive filtering operation to be performed on image data, in accordance with whether the image data is to be referred to by other image data, the control being performed by a filter control unit of an image processing device; and performing the adaptive filtering operation on the image data in a motion compensation loop, the adaptive filtering operation being performed by a filtering operation unit of the image processing device.

In an aspect of this disclosure, an adaptive filtering operation to be performed on image data is controlled in accordance with the type of each predetermined unit data of image data, and the adaptive filtering operation is performed on the image data in a motion compensation loop.

### EFFECTS OF THE INVENTION

According to this disclosure, images can be processed. Particularly, the load of image encoding operations can be reduced while restraining increases in image quality deterioration.

### BRIEF DESCRIPTION OF DRAWINGS

FIG. 1 is a block diagram showing an image encoding device that outputs compressed image information according to the AVC encoding method.

FIG. 2 is a block diagram showing an image decoding device that receives an input of compressed image information according to the AVC encoding method.

FIG. 3 is a diagram for explaining the operating principles of a deblocking filter.

FIG. 4 is a diagram for explaining a method of defining Bs.

FIG. 5 is a diagram for explaining the operating principles of a deblocking filter.

FIG. 6 is a diagram showing an example of correspondence relationships between indexA and indexB, and values of α and β.

FIG. 7 is a diagram showing an example of correspondence relationships among Bs, indexA, and tC0.

FIG. 8 is a block diagram showing an exemplary structure of part of an image encoding device using an adaptive loop filter.

FIG. 9 is a block diagram showing an exemplary structure of part of an image decoding device using an adaptive loop filter.

FIG. 10 is a block diagram showing a typical exemplary structure of an image encoding device.

FIG. 11 is a block diagram showing a typical exemplary structure of an adaptive loop filter.

FIG. 12 is a diagram for explaining an example of ON/OFF control performed by an adaptive loop filter.

FIG. 13 is a diagram for explaining another example of ON/OFF control performed by an adaptive loop filter.

FIG. 14 is a diagram for explaining an example of the syntax of a slice header.

FIG. 15 is a diagram for explaining an example of the parameter syntax of an adaptive loop filter.

FIG. 16 is a diagram for explaining an example of the parameter syntax of an adaptive loop filter, continued from FIG. 15.

FIG. 17 is a diagram for explaining an example of the parameter syntax of an adaptive loop filter, continued from FIG. 16.

FIG. 18 is a flowchart for explaining an example flow of an encoding operation.

FIG. 19 is a flowchart for explaining an example flow of an adaptive loop filtering operation.

FIG. 20 is a block diagram showing another exemplary structure of an adaptive loop filter.

FIG. 21 is a flowchart for explaining another example flow of an adaptive loop filtering operation.

FIG. 22 is a diagram for explaining examples of macroblocks.

FIG. 23 is a block diagram showing a typical exemplary structure of a personal computer.

FIG. 24 is a block diagram showing a typical exemplary structure of a television receiver.

FIG. 25 is a block diagram showing a typical exemplary structure of a portable telephone device.

FIG. 26 is a block diagram showing a typical exemplary structure of a hard disk recorder.

FIG. 27 is a block diagram showing a typical exemplary structure of a camera.

### MODE FOR CARRYING OUT THE INVENTION

The following is a description of modes for carrying out this technique (hereinafter referred to as embodiments). Explanation will be made in the following order.

### 1. First Embodiment (Image Encoding Device)

### 2. Second Embodiment (Image Encoding Device)

### 3. Third Embodiment (Personal Computer)

### 4. Fourth Embodiment (Television Receiver)

### 5. Fifth Embodiment (Portable Telephone Device)

### 6. Sixth Embodiment (Hard Disk Recorder)

### 7. Seventh Embodiment (Camera)

### 1. First Embodiment

### Image Encoding Device According to the AVC Encoding Method

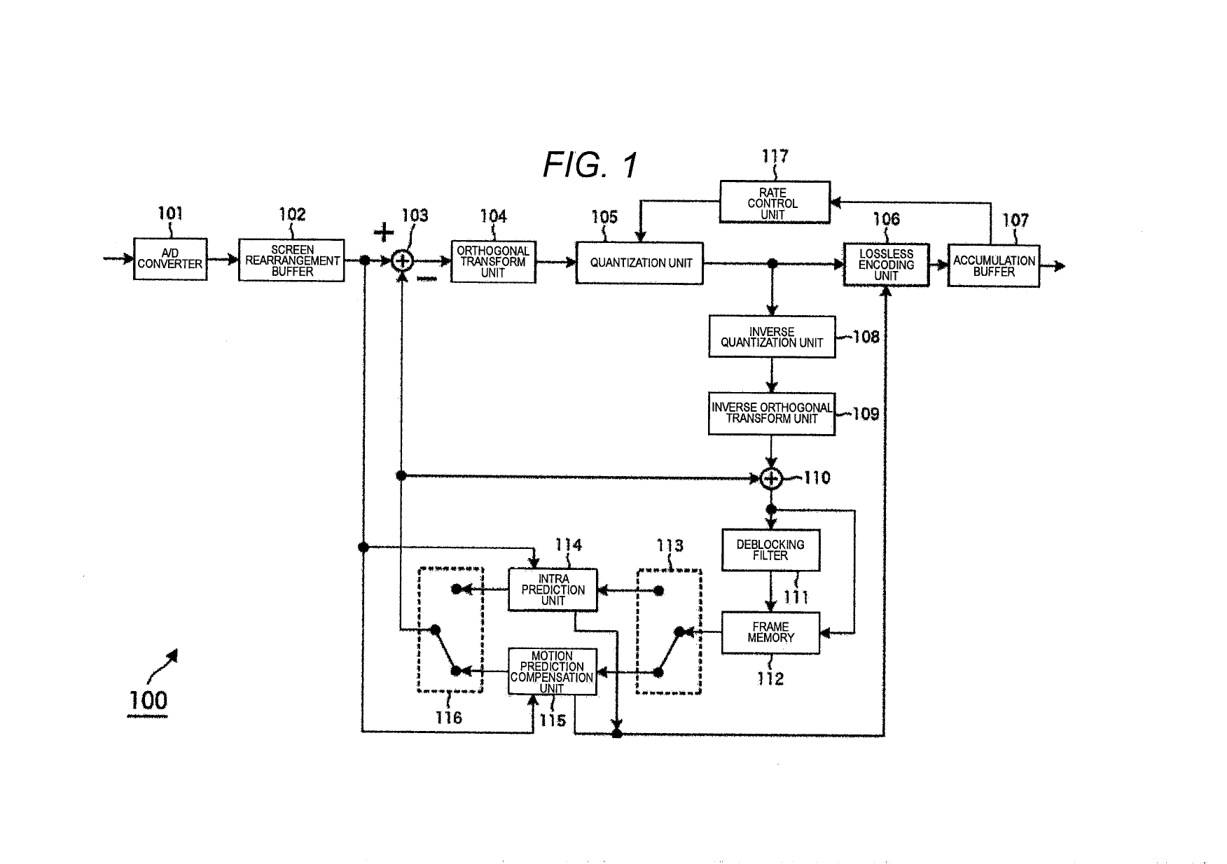

FIG. 1 shows the structure of an embodiment of an image encoding device that encodes images according to the AVC encoding method.

The image encoding device 100 shown in FIG. 1 is a device that encodes and outputs images by an encoding method compliant with the AVC standard. As shown in FIG. 1, the image encoding device 100 includes an A/D converter 101, a screen rearrangement buffer 102, an arithmetic operation unit 103, an orthogonal transform unit 104, a quantization unit 105, a lossless encoding unit 106, and an accumulation buffer 107. The image encoding device 100 also includes an inverse quantization unit 108, an inverse orthogonal transform unit 109, an arithmetic operation unit 110, a deblocking filter 111, a frame memory 112, a selection unit 113, an intra prediction unit 114, a motion prediction/compensation unit 115, a selection unit 116, and a rate control unit 117.

The A/D converter 101 subjects input image data to an A/D conversion, and outputs and stores the image data into the screen rearrangement buffer 102. The screen rearrangement buffer 102 rearranges the image frames stored in displaying order in accordance with the GOP (Group of Pictures) structure, so that the frames are arranged in encoding order. The screen rearrangement buffer 102 supplies the image having the rearranged frame order to the arithmetic operation unit 103. The screen rearrangement buffer 102 also supplies the image having the rearranged frame order to the intra prediction unit 114 and the motion prediction/compensation unit 115.

The arithmetic operation unit 103 subtracts a predicted image supplied from the intra prediction unit 114 or the motion prediction/compensation unit 115 via the selection unit 116, from the image read from the screen rearrangement buffer 102, and outputs the difference information to the orthogonal transform unit 104.

For example, when intra encoding is performed on an image, the arithmetic operation unit 103 subtracts a predicted image supplied from the intra prediction unit 114, from the image read from the screen rearrangement buffer 102. When inter encoding is performed on an image, the arithmetic operation unit 103 subtracts a predicted image supplied from the motion prediction/compensation unit 115, from the image read from the screen rearrangement buffer 102.

The orthogonal transform unit 104 performs an orthogonal transform operation, such as a discrete cosine transform or a Karhunen-Loeve transform, on the difference information supplied from the arithmetic operation unit 103, and supplies the transform coefficient to the quantization unit 105.

The quantization unit 105 quantizes the transform coefficient output from the orthogonal transform unit 104. Based on target bit rate value information supplied from the rate control unit 117, the quantization unit 105 sets a quantization parameter, and performs quantization. The quantization unit 105 supplies the quantized transform coefficient to the lossless encoding unit 106.

The lossless encoding unit 106 performs lossless encoding on the quantized transform coefficient through variable-length encoding or arithmetic encoding or the like. Since the coefficient data has already been quantized under the control of the rate control unit 117, the bit rate is equal to the target value (or approximates the target value) set by the rate control unit 117.

The lossless encoding unit 106 obtains information indicating an intra prediction or the like from the intra prediction unit 114, and obtains information indicating an inter prediction mode or motion vector information or the like from the motion prediction/compensation unit 115. The information indicating an intra prediction (an intra-screen prediction) will be hereinafter also referred to as intra prediction mode information. The information indicating an inter prediction (an inter-screen prediction) will be hereinafter referred to as inter prediction mode information.

The lossless encoding unit 106 not only encodes the quantized transform coefficient, but also incorporates (multiplexes) various kinds of information such as a filter coefficient, the intra prediction mode information, the inter prediction mode information, and the quantization parameter, into the header information of encoded data. The lossless encoding unit 106 supplies and stores the encoded data obtained through the encoding into the accumulation buffer 107.

For example, in the lossless encoding unit 106, a lossless encoding operation such as variable-length encoding or arithmetic encoding is performed. The variable-length encoding may be CAVLC (Context-Adaptive Variable Length Coding) specified in H.264/AVC, for example. The arithmetic encoding may be CABAC (Context-Adaptive Binary Arithmetic Coding).

The accumulation buffer 107 temporarily stores the encoded data supplied from the lossless encoding unit 106, and outputs the encoded data as an encoded image encoded by H.264/AVC to a recording device or a transmission path (not shown) in a later stage at a predetermined time, for example.

The transform coefficient quantized at the quantization unit 105 is also supplied to the inverse quantization unit 108. The inverse quantization unit 108 inversely quantizes the quantized transform coefficient by a method compatible with the quantization performed by the quantization unit 105. The inverse quantization unit 108 supplies the obtained transform coefficient to the inverse orthogonal transform unit 109.

The inverse orthogonal transform unit 109 performs an inverse orthogonal transform on the supplied transform coefficient by a method compatible with the orthogonal transform operation performed by the orthogonal transform unit 104. The output subjected to the inverse orthogonal transform (the uncompressed difference information) is supplied to the arithmetic operation unit 110.

The arithmetic operation unit 110 obtains a locally decoded image (a decoded image) by adding the predicted image supplied from the intra prediction unit 114 or the motion prediction/compensation unit 115 via the selection unit 116 to the inverse orthogonal transform result supplied from the inverse orthogonal transform unit 109 or the uncompressed difference information.

For example, when the difference information is compatible with an image to be intra-encoded, the arithmetic operation unit 110 adds the predicted image supplied from the intra prediction unit 114 to the difference information. When the difference information is compatible with an image to be inter-encoded, the arithmetic operation unit 110 adds the predicted image supplied from the motion prediction/compensation unit 115 to the difference information, for example.

The addition result is supplied to the deblocking filter 111 or the frame memory 112.

The deblocking filter 111 removes block distortions from the decoded image by performing a deblocking filtering operation where necessary, and performs a loop filtering operation, where necessary, by using a Wiener filter, for example, to improve image quality. The deblocking filter 111 classifies respective pixels into classes, and performs an appropriate filtering operation on each of the classes. The deblocking filter 111 supplies the filtering operation results to the frame memory 112.

The frame memory 112 outputs a stored reference image to the intra prediction unit 114 or the motion prediction/compensation unit 115 via the selection unit 113 at a predetermined time.

For example, when intra encoding is performed on an image, the frame memory 112 supplies the reference image to the intra prediction unit 114 via the selection unit 113. When inter encoding is performed on an image, the frame memory 112 supplies the reference image to the motion prediction/compensation unit 115 via the selection unit 113, for example.

When the reference image supplied from the frame memory 112 is an image to be subjected to intra encoding, the selection unit 113 supplies the reference image to the intra prediction unit 114. When the reference image supplied from the frame memory 112 is an image to be subjected to inter encoding, the selection unit 113 supplies the reference image to the motion prediction/compensation unit 115.

The intra prediction unit 114 performs intra predictions (intra-screen predictions) to generate a predicted image by using the pixel values in the screen. The intra prediction unit 114 performs intra predictions in more than one mode (intra prediction modes).

By the H.264 image information encoding method, an intra 4×4 prediction mode, an intra 8×8 prediction mode, and an intra 16×16 prediction mode are defined for luminance signals. As for chrominance signals, prediction modes for respective macroblocks can be defined independently of the luminance signals. In the intra 4×4 prediction mode, one intra prediction mode is defined for each 4×4 luminance block. In the intra 8×8 prediction mode, one intra prediction mode is defined for each 8×8 luminance block. In the intra 16×16 prediction mode and for the chrominance signals, one prediction mode is defined for each macroblock.

The intra prediction unit 114 generates predicted images in all the intra prediction modes, evaluates the respective predicted images, and selects an optimum mode. After selecting the optimum intra prediction mode, the intra prediction unit 114 supplies the predicted image generated in the optimum intra prediction mode to the arithmetic operation unit 103 and the arithmetic operation unit 110 via the selection unit 116.

As described above, the intra prediction unit 114 also supplies information such as the intra prediction mode information indicating the selected intra prediction mode to the lossless encoding unit 106 where appropriate.

Using the input image supplied from the screen rearrangement buffer 102, and a reference image supplied from the frame memory 112 via the selection unit 113, the motion prediction/compensation unit 115 performs a motion prediction on an image to be subjected to inter encoding, and performs a motion compensating operation in accordance with the detected motion vectors, to generate a predicted image (inter predicted image information).

The motion prediction/compensation unit 115 performs inter predicting operations in all candidate inter prediction modes, to generate a predicted image. The motion prediction/compensation unit 115 supplies the generated predicted image to the arithmetic operation unit 103 and the arithmetic operation unit 110 via the selection unit 116.

The motion prediction/compensation unit 115 supplies the inter prediction mode information indicating the selected inter prediction mode, and motion vector information indicating the calculated motion vectors to the lossless encoding unit 106.

When intra encoding is performed on an image, the selection unit 116 supplies the output of the intra prediction unit 114 to the arithmetic operation unit 103 and the arithmetic operation unit 110. When inter encoding is performed on an image, the selection unit 116 supplies the output of the motion prediction/compensation unit 115 to the arithmetic operation unit 103 and the arithmetic operation unit 110.

Based on the compressed images stored in the accumulation buffer 107, the rate control unit 117 controls the quantizing operation rate of the quantization unit 105 so as not to cause an overflow or underflow.

### [Image Decoding Device According to the AVC Encoding Method]

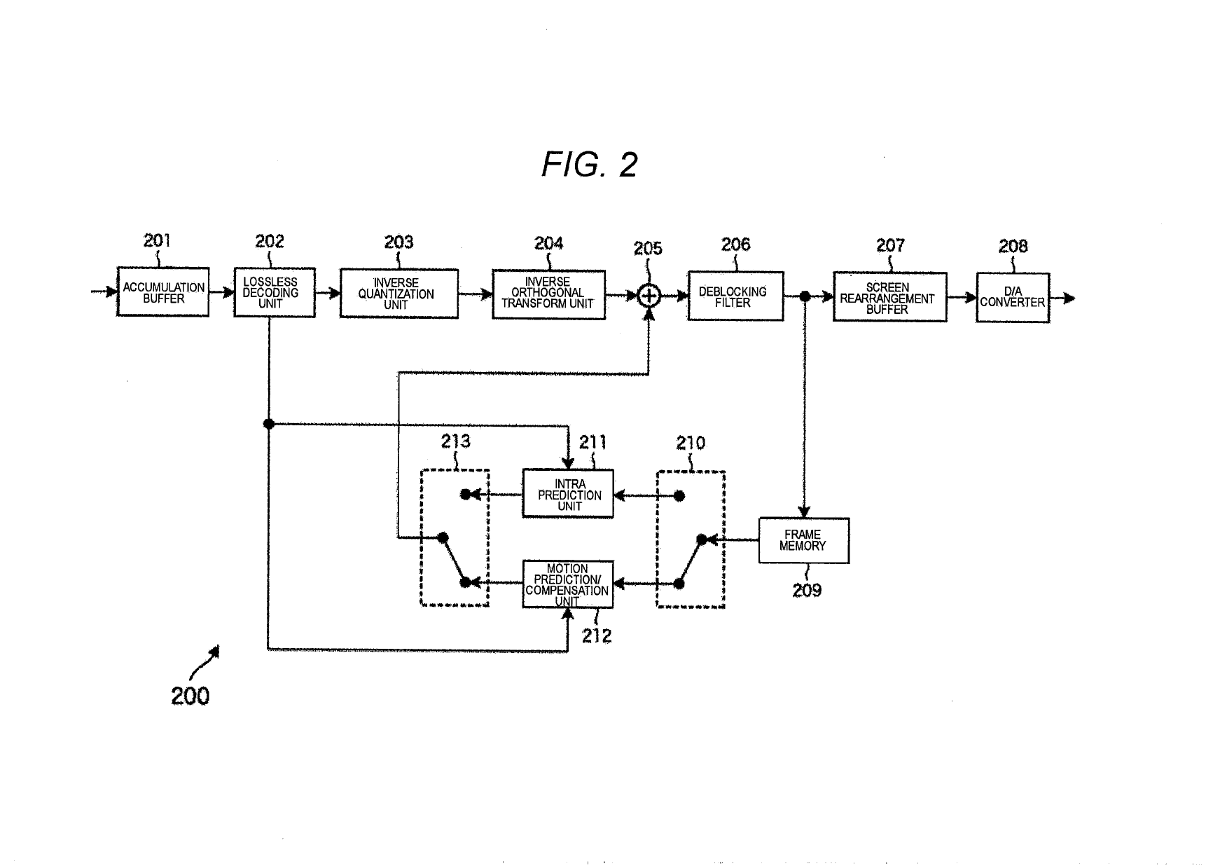

FIG. 2 is a block diagram showing a typical exemplary structure of an image decoding device that realizes image compression through orthogonal transforms, such as discrete cosine transforms or Karhunen-Loeve transforms, and motion compensation. The image decoding device 200 shown in FIG. 2 is a decoding device that is compatible with the image encoding device 100.

Data encoded by the image encoding device 100 is supplied to the image decoding device 200 compatible with the image encoding device 100 via a predetermined transmission path, for example, and is decoded.

As shown in FIG. 2, the image decoding device 200 includes an accumulation buffer 201, a lossless decoding unit 202, an inverse quantization unit 203, an inverse orthogonal transform unit 204, an arithmetic operation unit 205, a deblocking filter 206, a screen rearrangement buffer 207, and a D/A converter 208. The image decoding device 200 also includes a frame memory 209, a selection unit 210, an intra prediction unit 211, a motion prediction/compensation unit 212, and a selection unit 213.

The accumulation buffer 201 stores transmitted encoded data. The encoded data has been encoded by the image encoding device 100. The lossless decoding unit 202 decodes the encoded data read from the accumulation buffer 201 at a predetermined time, by a method compatible with the encoding method used by the lossless encoding unit 106 shown in FIG. 1.

When the frame is an intra-encoded frame, the header portion of the encoded data stores intra prediction mode information. The lossless decoding unit 202 also decodes the intra prediction mode information, and supplies the information to the intra prediction unit 211. When the frame is an inter-encoded frame, on the other hand, the header portion of the encoded data stores motion vector information. The lossless decoding unit 202 also decodes the motion vector information, and supplies the information to the motion prediction/compensation unit 212.

The inverse quantization unit 203 inversely quantizes the coefficient data (the quantized coefficient) decoded by the lossless decoding unit 202 by a method compatible with the quantization method used by the quantization unit 105 shown in FIG. 1. That is, the inverse quantization unit 203 inversely quantizes the quantized coefficient by the same method as the method used by the inverse quantization unit 108 shown in FIG. 1.

The inverse quantization unit 203 supplies the inversely-quantized coefficient data, or the orthogonal transform coefficient, to the inverse orthogonal transform unit 204. The inverse orthogonal transform unit 204 subjects the orthogonal transform coefficient to an inverse orthogonal transform by a method compatible with the orthogonal transform method used by the orthogonal transform unit 104 shown in FIG. 1 (the same method as the method used by the inverse orthogonal transform unit 109 shown in FIG. 1), and obtains decoded residual error data corresponding to the residual error data from the time prior to the orthogonal transform performed by the image encoding device 100.

The decoded residual error data obtained through the inverse orthogonal transform is supplied to the arithmetic operation unit 205. A predicted image is also supplied to the arithmetic operation unit 205 from the intra prediction unit 211 or the motion prediction/compensation unit 212 via the selection unit 213.

The arithmetic operation unit 205 adds the decoded residual error data to the predicted image, and obtains decoded image data corresponding to the image data from the time prior to the predicted image subtraction performed by the arithmetic operation unit 103 of the image encoding device 100. The arithmetic operation unit 205 supplies the decoded image data to the deblocking filter 206.

The deblocking filter 206 removes block distortions from the supplied decoded images, and supplies the images to the screen rearrangement buffer 207.

The screen rearrangement buffer 207 performs image rearrangement. Specifically, the frame order rearranged in the encoding order of by the screen rearrangement buffer 102 of FIG. 1 is rearranged in the original display order. The D/A converter 208 performs a D/A conversion on the images supplied from the screen rearrangement buffer 207, and outputs the converted images to a display (not shown) to display the images.

The output of the deblocking filter 206 is further supplied to the frame memory 209.

The frame memory 209, the selection unit 210, the intra prediction unit 211, the motion prediction/compensation unit 212, and the selection unit 213 are equivalent to the frame memory 112, the selection unit 113, the intra prediction unit 114, the motion prediction/compensation unit 115, and the selection unit 116 of the image encoding device 100, respectively.

The selection unit 210 reads an image to be inter-processed and an image to be referred to from the frame memory 209, and supplies the images to the motion prediction/compensation unit 212. The selection unit 210 also reads an image to be used for intra predictions from the frame memory 209, and supplies the image to the intra prediction unit 211.

Information that has been obtained by decoding the header information and indicates an intra prediction mode or the like is supplied, where appropriate, from the lossless decoding unit 202 to the intra prediction unit 211. Based on the information, the intra prediction unit 211 generates a predicted image from the reference image obtained from the frame memory 209, and supplies the generated predicted image to the selection unit 213.

The motion prediction/compensation unit 212 obtains the information obtained by decoding the header information (prediction mode information, motion vector information, reference frame information, a flag, respective parameters, and the like), from the lossless decoding unit 202.

Based on the information supplied from the lossless decoding unit 202, the motion prediction/compensation unit 212 generates a predicted image from the reference image obtained from the frame memory 209, and supplies the generated predicted image to the selection unit 213.

The selection unit 213 selects a predicted image generated by the motion prediction/compensation unit 212 or the intra prediction unit 211, and supplies the selected predicted image to the arithmetic operation unit 205.

### [Orthogonal Transforms]

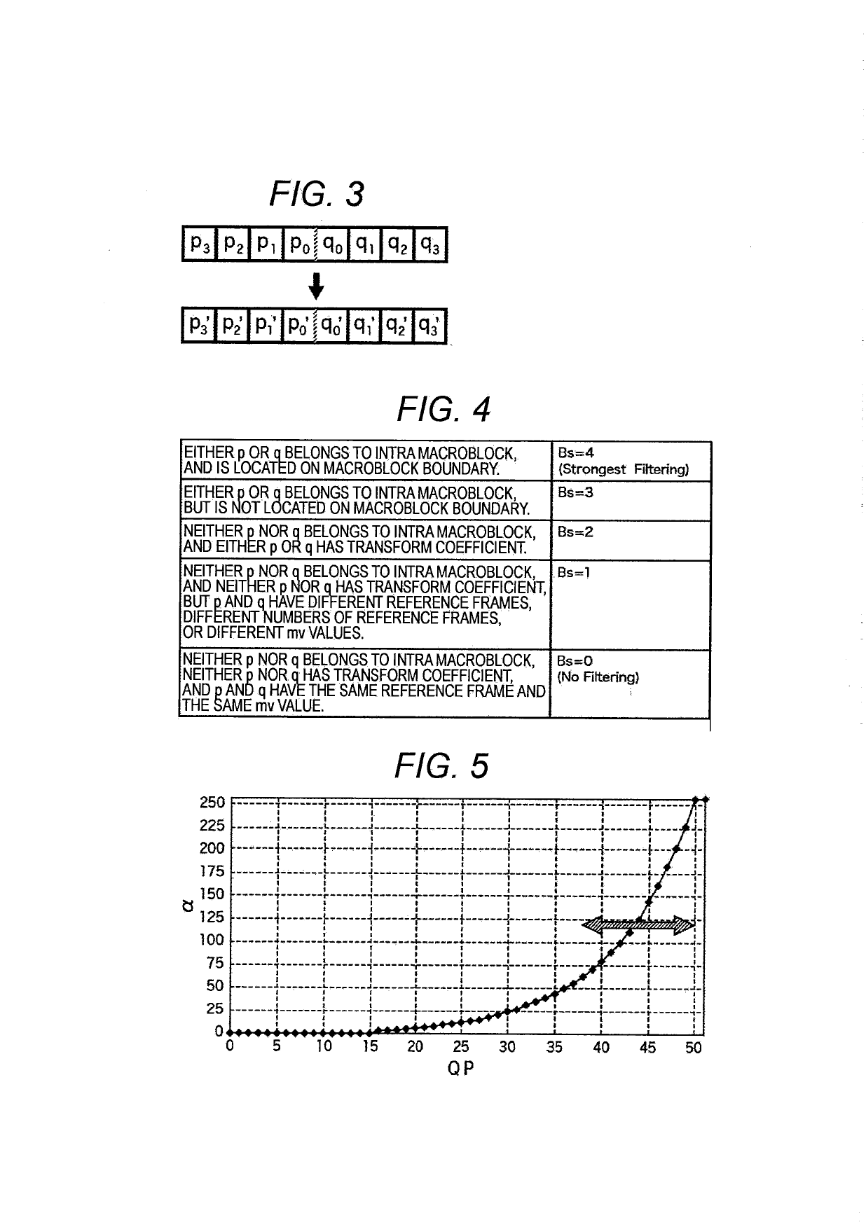

Meanwhile, by the AVC encoding method, only 4×4 orthogonal transforms can be used as orthogonal transforms in Baseline Profile, Extended Profile, and Main Profile. In High Profile and higher, an operation can be switched between a 4×4 orthogonal transform and an 8×8 orthogonal transform in a screen, as shown in FIG. 3.

### [Deblocking Filter]

By the AVC encoding method, a deblocking filter is included in each loop, as shown in FIGS. 1 and 2. With this arrangement, block distortions can be effectively removed from decoded images, and motion compensation can effectively prevent the block distortions from propagating to images referring to the decoded image.

In the following, the operating principles in each deblocking filter according to the AVC encoding method are described.

As operations of a deblocking filter, the following three operations can be designated in accordance with the two parameters, deblocking_filter_control_present_flag in Picture Parameter Set RBSP and disable_deblocking_filter_idc in Slice Header, which are contained in compressed image information.

(a) To be performed on a block boundary or a macroblock boundary

(b) To be performed only on a macroblock boundary

(c) Not to be performed

As for the quantization parameter QP, QP_{Y} is used when the following operation is performed on luminance signals, and QP_{C} is used when the following operation is performed on chrominance signals. In motion vector encoding, intra predictions, and entropy encoding (CAVLC/CABAC), pixel values that belong to a different slice are processed as “not available”. However, in deblocking filtering operations, pixel values that belong to a different slice but belong to the same picture are processed as “available.

In the following, pixel values yet to be subjected to a deblocking filtering operation are represented by p0 through p3 and q0 through q3, and processed pixel values are represented by p0′ through p3′ and q0′ through q3′, as shown in FIG. 3.

As shown in FIG. 4, prior to a deblocking filtering operation, Bs (Boundary strengths) are defined on the ps and qs shown in FIG. 3.

Only when the following two conditions (the expression (1) and the expression (2)) are satisfied, is a deblocking filtering operation performed on (p2, p1, p0, q0, q1, and q2) in FIG. 3.

Bs>0 (1)

|p0−q0|<α; |p1−p0|<β; |q1−q0|<β (2)

Although the default values of α and β in the expression (2) are defined in accordance with QP as shown below, the values can be adjusted by a user in accordance with the two parameters “slice_alpha_c0_offset_div2” and “slice_beta_offset_div2” contained in the slice header in compressed image information (or in encoded data), as shown in FIG. 5.

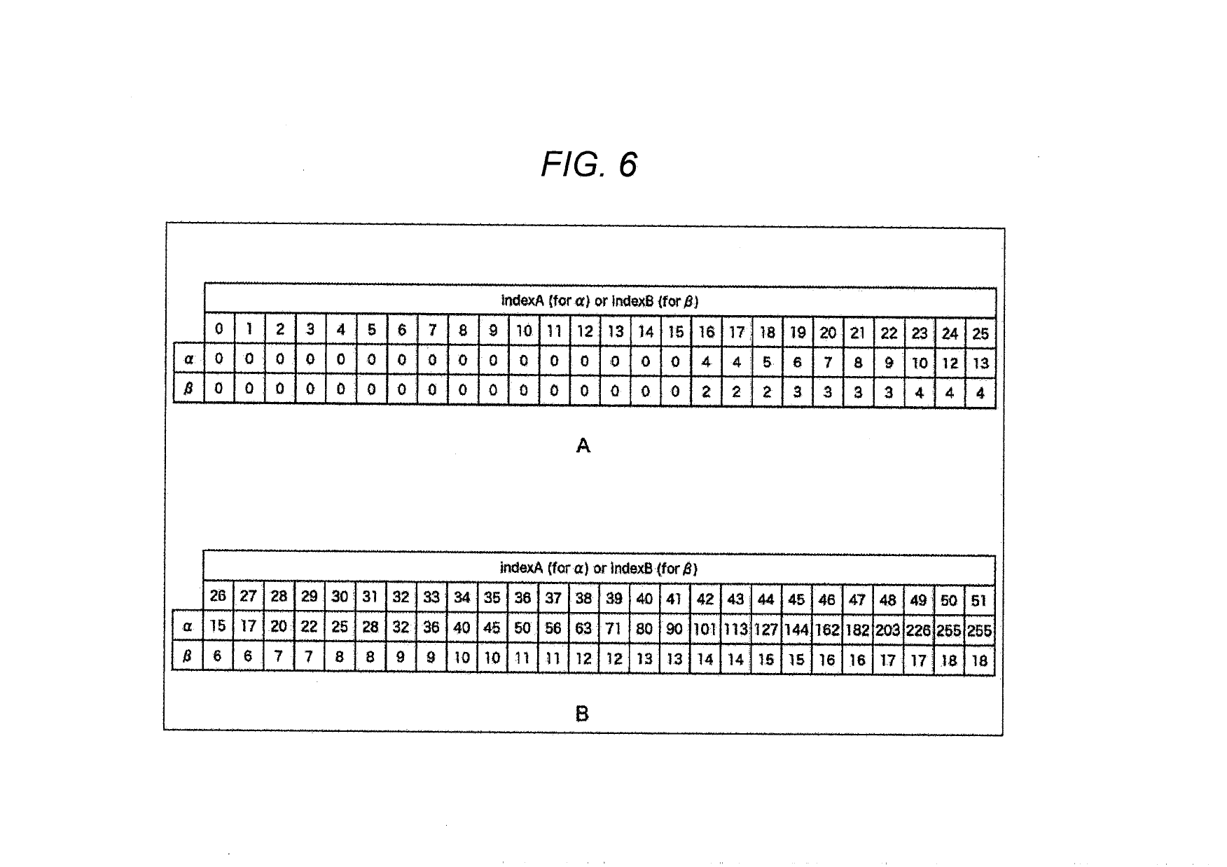

The indexA and indexB shown in the tables in FIGS. 6A and 6B are defined as shown in the following expressions (3) through (5).

[Mathematical Formula 1]

gPₐᵥ=(qPₚ+qP_{q}+1)>>1 (3)

[Mathematical Formula 2]

indexA=Clip3(0,51,qPₐᵥ+FilterOffsetA) (4)

[Mathematical Formula 3]

indexB=Clip3(0,51,qPₐᵥ+FilterOffsetB) (5)

In the above expressions (3) through (5), “FilterOffsetA” and “FilterOffsetB” are the portions to be adjusted by a user.

Different methods are defined as deblocking filtering operations in cases (1) where Bs<4, and (2) where Bs=4, as described below.

Where Bs<4, the pixel values p′0 and q′0 subjected to the deblocking filtering operation are calculated according to the following expressions (6) through (8).

[Mathematical Formula 4]

Δ=Clip3(−t_{C},tc,((((q₀−p₀)<<2)+(p₁−q₁)+4)>>3)) (6)

[Mathematical Formula 5]

p₀′=Clip1(p₀+Δ) (7)

[Mathematical Formula 6]

q₀′=Clip1(q₀+Δ) (8)

Here, t_{c} is calculated as described below. That is, where the value of chromaEdgeFlag is 0, t_{c} is calculated according to the expression (9) shown below. In other cases, t_{c} is calculated according to the expression (10) shown below.

[Mathematical Formula 7]

t_{C}=t_{C0}+((aₚ<β)?1:0)+((a_{q}<β)?1:0) (9)

[Mathematical Formula 8]

t_{C}=t_{C0}+1 (10)

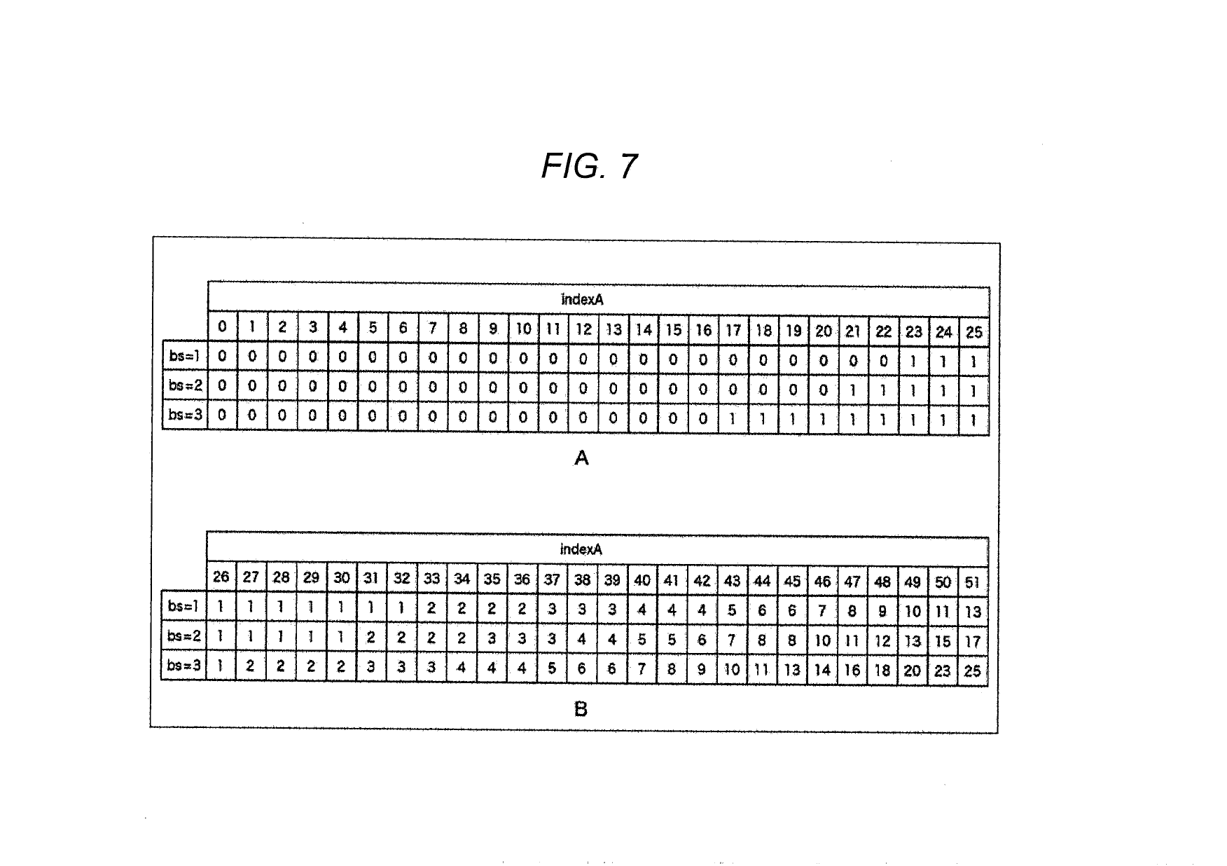

The value of t_{c0} is defined in accordance with the values of Bs and indexA, as shown in the tables in FIGS. 7A and 7B. Also, the values of aₚ and a_{q} are calculated according to the following expressions (11) and (12).

[Mathematical Formula 9]

aₚ=|p₂−p₀| (11)

[Mathematical Formula 10]

a_{q}=|q₂−q₀| (12)

The pixel value p′₁ subjected to the deblocking filtering operation is calculated as described below. That is, when the value of chromaEdgeFlag is 0, and the value of aₚ is equal to or smaller than β, p′₁ is calculated according to the expression (13) shown below. When this condition is not satisfied, p′₁ is calculated according to the expression (14) shown below.

[Mathematical Formula 11]

p′₁=p₁+Clip3(−t_{C0},t_{C0},(p₂+((p₀+q₀+1)>>1)−(p₁<<1))>>1) (13)

[Mathematical Formula 12]

p′₁=p₁ (14)

The pixel value q′₁ subjected to the deblocking filtering operation is calculated as described below. That is, when the value of chromaEdgeFlag is 0, and the value of a_{q} is equal to or smaller than β, q′₁ is calculated according to the expression (15) shown below. When this condition is not satisfied, q′₁ is calculated according to the expression (16) shown below.

[Mathematical Formula 13]

q′₁=q₁+Clip3(−t_{C0},t_{C0},(q₂+((p₀+q₀+1)>>1)−(q₁<<1))>>1) (15)

[Mathematical Formula 14]

q′₁=q₁ (16)

The values of p′₂ and q′₂ are the same as the values of p₂ and q₂, which have not been filtered yet. That is, p′₂ and q′₂ are calculated according to the following expressions (17) and (18):

[Mathematical Formula 15]

p′₂=p₂ (17)

[Mathematical Formula 16]

q′₂=q₂ (18)

Where Bs=4, the pixel values p′_{I} (i=0, . . . , 2) subjected to the deblocking filtering operation are calculated as described below. That is, when the value of chromaEdgeFlag is 0, and the condition shown below (the expression (19)) is satisfied, p′₀, p′₁, and p′₂ are calculated according to the expressions (20) through (22) shown below. When the above mentioned condition is not satisfied, p′₀, p′₁, and p′₂ are calculated according to the expressions (23) through (25) shown below.

[Mathematical Formula 17]

aₚ<β&&|p₀−q₀|<((α>>2)+2) (19)

[Mathematical Formula 18]

p₀′=(p₂+2·p₁+2·p₀+2·q₀+q₁+4)>>3 (20)

[Mathematical Formula 19]

p₁′=(p₂+p₁+p₀+q₀+2)>>2 (21)

[Mathematical Formula 20]

p₂′=(2·p₃+3·p₂+p₁+q₀+4)>>3 (22)

[Mathematical Formula 21]

p₀′=(2·p₁+p₀+q₁+2)>>2 (23)

[Mathematical Formula 22]

p₁′=p₁ (24)

[Mathematical Formula 23]

p₂′=p₂ (25)

The pixel values q′ᵢ (i=0, . . . , 2) subjected to the deblocking filtering operation are calculated as described below. That is, when the value of chromaEdgeFlag is 0, and the condition shown below (the expression (26)) is satisfied, q′₀, q′₁, and q′₂ are calculated according to the expressions (27) through (29) shown below. When the above mentioned condition is not satisfied, q′₀, q′₁, and q′₂ are calculated according to the expressions (30) through (32) shown below.

[Mathematical Formula 24]

a_{q}<β&&|p₀−q₀|<((α>>2)+2) (26)

[Mathematical Formula 25]

q′₀=(p₁+2·p₀+2·q₀+2·q₁+q₂+4)>>3 (27)

[Mathematical Formula 26]

q₁′=(p₀+q₀+q₁+q₂+2)>>2 (28)

[Mathematical Formula 27]

q₂′=(2·q₃+3·q₂+q₁+q₀+p₄+4)>>3 (29)

[Mathematical Formula 28]

q′₀=(2·q₁+q₀+p₁+2)>>2 (30)

[Mathematical Formula 29]

q′₁=q₁ (31)

[Mathematical Formula 30]

q′₂=q₂ (32)

### [Loop Filter]

As described above, the following technique is disclosed as a technique for improving encoding efficiency in Non-Patent Document 1.

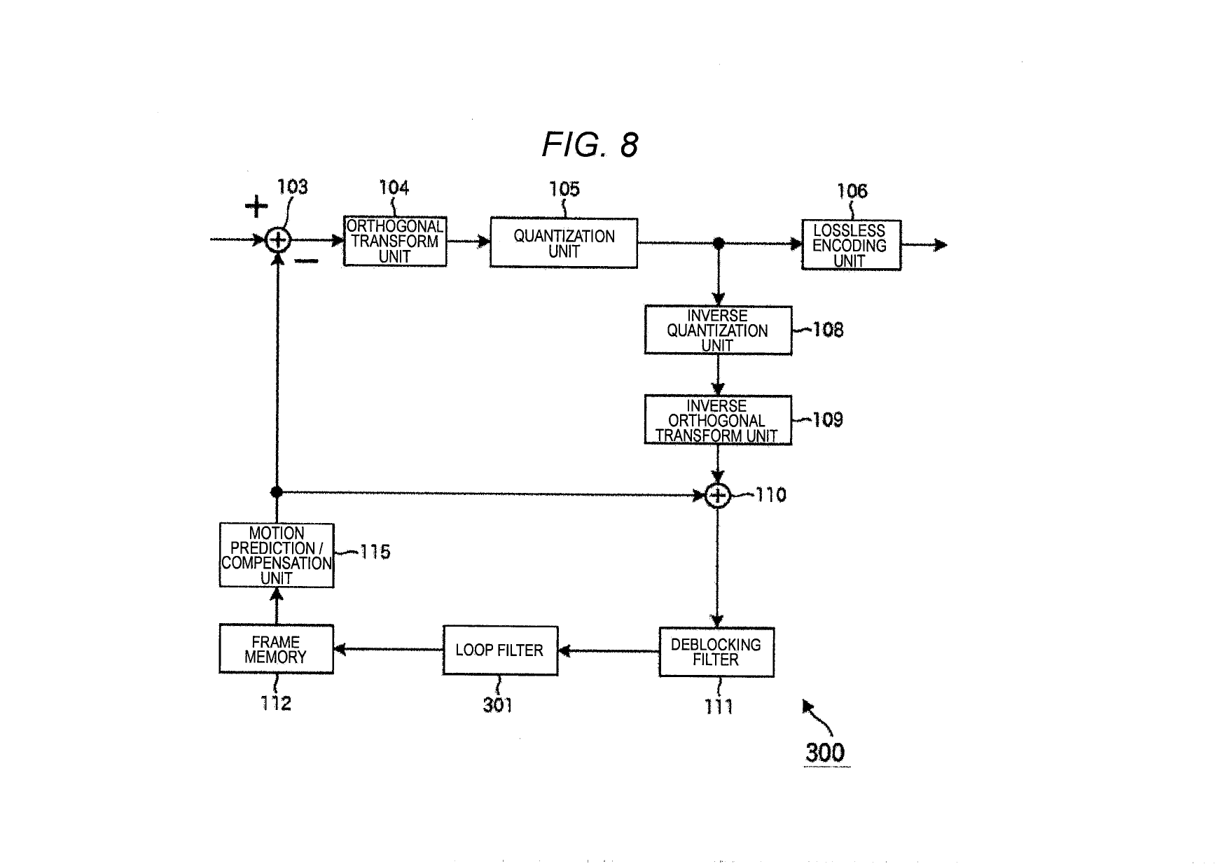

FIG. 8 is a block diagram showing an exemplary structure of part of an image encoding device disclosed in Non-Patent Document 1. The image encoding device 300 disclosed in Non-Patent Document 1 basically has the same structure as the image encoding device 100 that has been described with reference to FIG. 1 and encodes images by the AVC encoding method, but further includes a loop filter 301 as shown in FIG. 8.

The loop filter 301 is a Wiener filter that calculates a loop filter coefficient so as to minimize the residual error with respect to the original image, performs a filtering operation on pixel values subjected to a deblocking filtering operation by using the loop filter coefficient, and supplies and stores the filtering operation result into the frame memory 112.

This loop filter coefficient is supplied to the lossless encoding unit 106, and is encoded (is added to encoded data of image data). That is, the loop filter coefficient is supplied to an image decoding device.

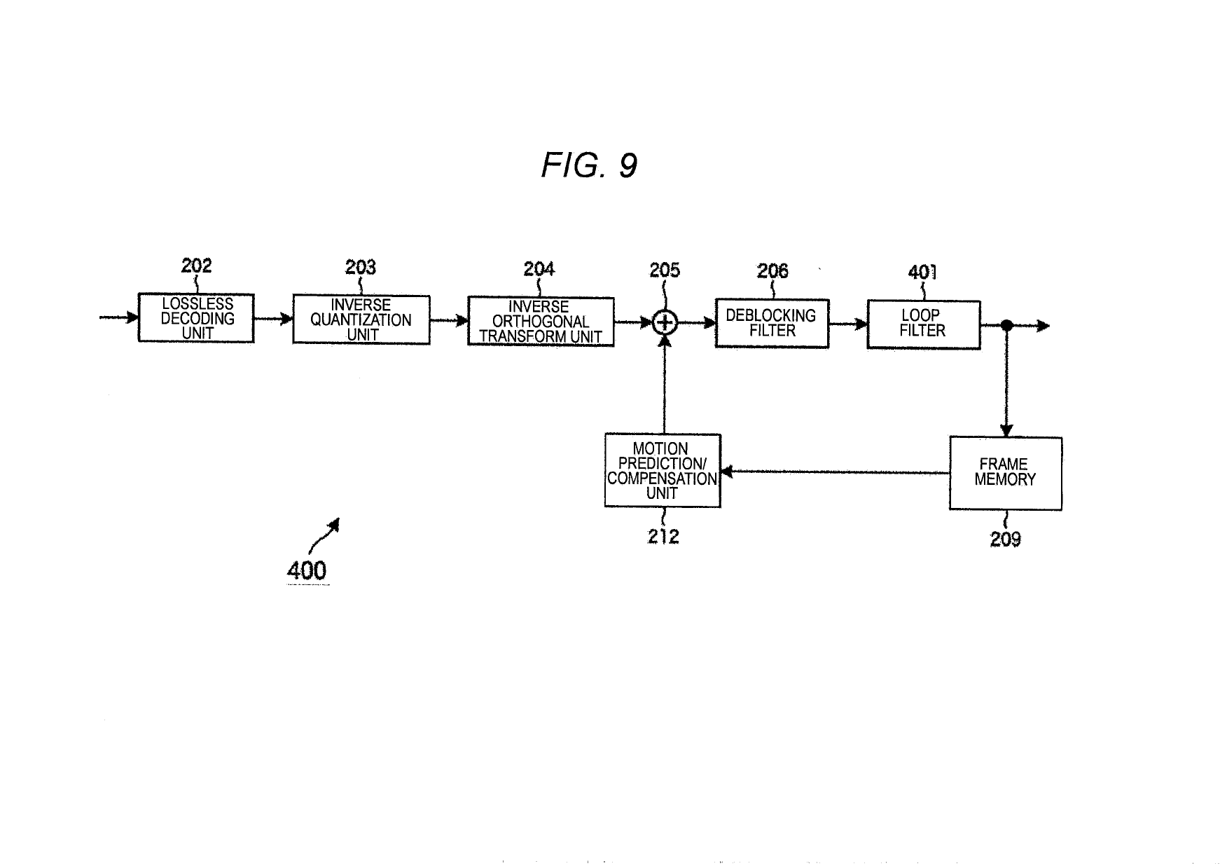

FIG. 9 is a block diagram showing an exemplary structure of part of an image decoding device compatible with the image encoding device 300 shown in FIG. 8. The image decoding device 400 basically has the same structure as the image decoding device 200 that has been described with reference to FIG. 2 and decodes encoded data of an image encoded by the AVC encoding method, but further includes a loop filter 401 as shown in FIG. 9.

The loop filter 401 is a Wiener filter that obtains the loop filter coefficient supplied together with encoded data from the image encoding device 300, performs a filtering operation on the pixel values subjected to a deblocking filtering operation by using the loop filter coefficient, and supplies the filtering operation result to the frame memory 209 and the like.

In this manner, the image quality of decoded images can be increased. Further, the image quality of reference images can also be increased.

### [Prediction Mode Selection]

The macroblock size of 16×16 pixels is not optimal for an UHD (Ultra High Definition: 4000×2000 pixels) frame to be encoded by a next-generation encoding method. In view of this, macroblock sizes such as 32×32 pixels and 64×64 pixels have been suggested.

To achieve a higher encoding efficiency, it is critical to select an appropriate prediction mode. For example, it is possible to select a method from the two mode determination methods: High Complexity Mode and Low Complexity Mode. By either of the methods, the cost function value as to each prediction mode Mode is calculated, and the prediction mode that minimizes the cost function value is selected as the optimum mode for the block or macroblock.

A cost function in the High Complexity Mode can be calculated according to the following expression (33):

Cost(ModeεΩ)=D+λ×R (33)

In the expression (33), Ω represents the universal set of the candidate prediction modes for encoding the block or macroblock. D represents the difference energy between a decoded image and an input image in a case where encoding is performed in the prediction mode Mode. Further, λ represents the Lagrange's undetermined multiplier provided as the quantization parameter function. R represents the total bit rate in a case where encoding is performed in the mode Mode, including the orthogonal transform coefficient.

That is, to perform encoding in the High Complexity Mode, a provisional encoding operation needs to be performed in all the candidate prediction modes Mode to calculate the above, parameters D and R, and therefore, a larger amount of calculation is required.

On the other hand, a cost function in the Low Complexity Mode can be calculated according to the following expression (34):

Cost(ModeεΩ))=D+QP2Quant(QP)×HeaderBit (34)

In the expression (34), D differs from that in the High Complexity Mode, and represents the difference energy between a predicted image and an input image. QP2Quant (QP) represents the function of the quantization parameter QP. Further, HeaderBit represents the bit rate related to information that excludes the orthogonal transform coefficient and belongs to Header, such as motion vectors and the mode.

That is, in the Low Complexity Mode, a predicting operation needs to be performed for each of the candidate modes Mode, but a decoded image is not required. Therefore, there is no need to perform an encoding operation. Accordingly, the calculation amount is smaller than that in the High Complexity Mode.

Since using the adaptive loop filter suggested in Non-Patent Document 1 for all the pictures and slices in the sequence requires an enormous amount of calculation as described above, there is a possibility of an increase in the image encoding operation load.

In view of this, an image encoding device that performs loop filtering operations in such a manner as not to increase the load is now described in the following.

### [Image Encoding Device]

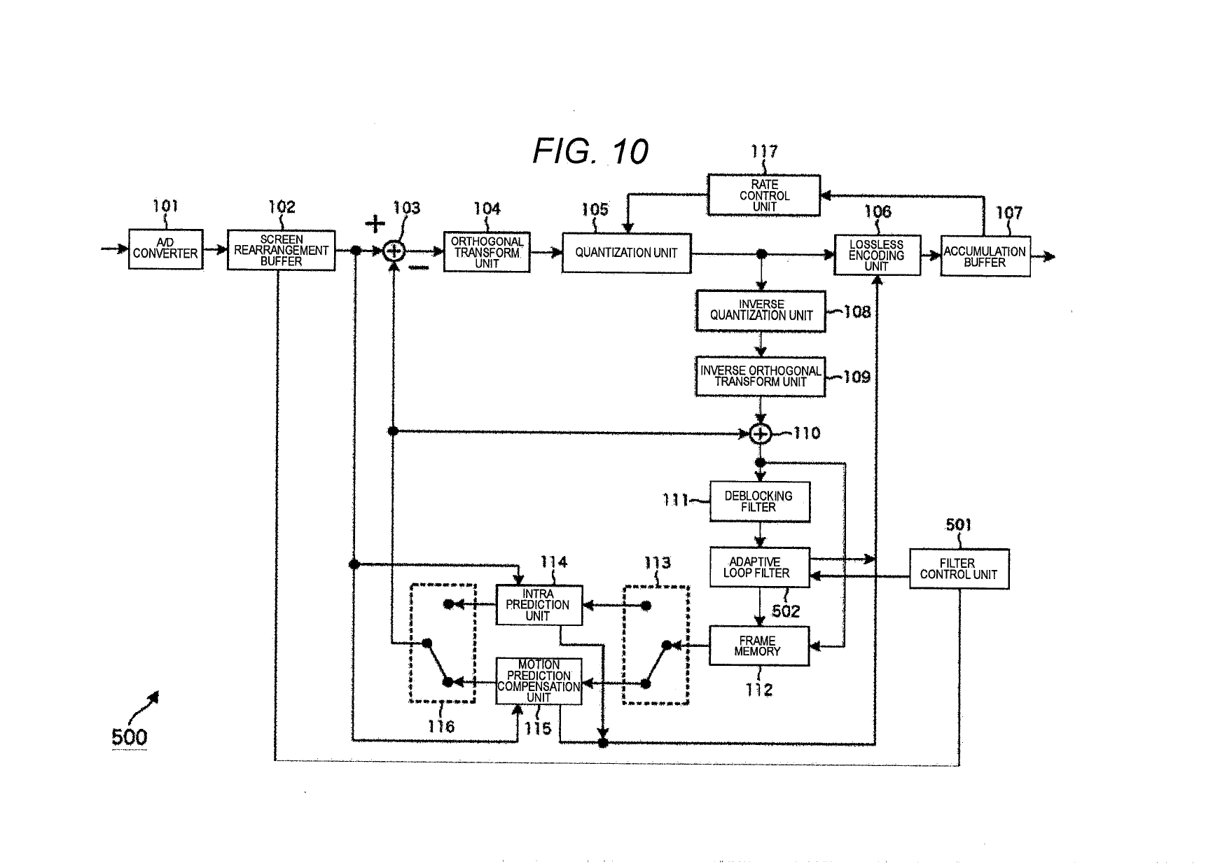

FIG. 10 shows the structure of an embodiment of an image encoding device as an image processing device.

The image encoding device 500 of FIG. 10 is the same as the image encoding device 100 of FIG. 1 in including an A/D converter 101, a screen rearrangement buffer 102, an arithmetic operation unit 103, an orthogonal transform unit 104, a quantization unit 105, a lossless encoding unit 106, an accumulation buffer 107, an inverse quantization unit 108, an inverse orthogonal transform unit 109, an arithmetic operation unit 110, a deblocking filter 111, a frame memory 112, a selection unit 113, an intra prediction unit 114, a motion prediction/compensation unit 115, a selection unit 116, and a rate control unit 117.

The image encoding device 500 of FIG. 10 differs from the image encoding device 100 of FIG. 1 in further including a filter control unit 501 and an adaptive loop filter 502.

The adaptive loop filter 502 is provided between the deblocking filter 111 and the frame memory 112. That is, the adaptive loop filter 502 is provided in the loop formed with the arithmetic operation unit 103, the orthogonal transform unit 104, the quantization unit 105, the inverse quantization unit 108, the inverse orthogonal transform unit 109, the arithmetic operation unit 110, the deblocking filter 111, the frame memory 112, the selection unit 113, the intra prediction unit 114 or the motion prediction/compensation unit 115, and the selection unit 116. Accordingly, images are looped over in the motion compensation loop.

The filter control unit 501 obtains, from the screen rearrangement buffer 102, information about the type of the image (a picture or a slice) to be subjected to an adaptive loop filtering operation. In accordance with the type, the filter control unit 501 controls whether to perform a filtering operation on the output from the deblocking filter 111 with the adaptive loop filter 502 (switching on/off of the adaptive loop filter).

For example, only when the image to be subjected to an adaptive loop filtering operation is an “image to be referred to”, does the filter control unit 501 turn on the adaptive loop filter (which is turned off for any other images). More specific examples of control methods will be described later.

Under the control of the filter control unit 501, the adaptive loop filter 502 calculates a filter coefficient, performs a filtering operation on an image output from the deblocking filter by using the calculated filter coefficient, and outputs the filtered image to the frame memory 112. This filter may be a Wiener filter, for example.

Also, the adaptive loop filter 502 sends flag information (an ON/OFF flag) indicating the calculated filter coefficient and switching on/off of the filtering operation, to the lossless encoding unit 106. The lossless encoding unit 106 also encodes the filter coefficient and the ON/OFF flag, and adds the encoding results to encoded data.

### [Details of the Adaptive Loop Filter]

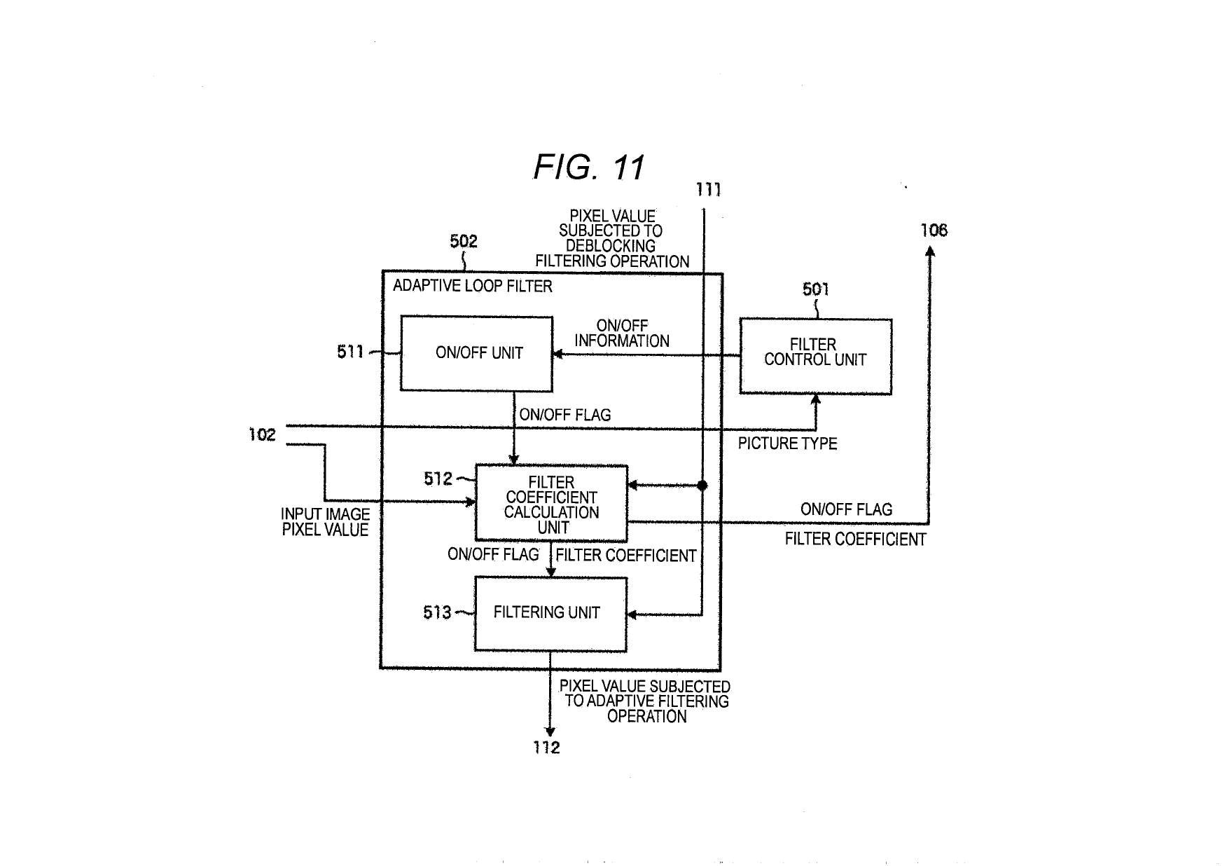

FIG. 11 is a block diagram showing a typical exemplary structure of the adaptive loop filter 502. As shown in FIG. 11, the adaptive loop filter 502 includes an ON/OFF unit 511, a filter coefficient calculation unit 512, and a filtering unit 513.

The information about the type of the image to be subjected to an adaptive loop filtering operation, such as a picture type or a slice type, is supplied from the screen rearrangement buffer 102 to the filter control unit 501. Based on the information, the filter control unit 501 generates the ON/OFF information for determining (controlling) switching on/off of the adaptive loop filter, and supplies the ON/OFF information to the ON/OFF unit 511 of the adaptive loop filter 502.

In accordance with the value of the ON/OFF information supplied from the filter control unit 501, the ON/OFF unit 511 generates the ON/OFF flag for controlling the operation of the filter coefficient calculation unit 512, and supplies the ON/OFF flag to the filter coefficient calculation unit 512. When the ON/OFF information that sets the adaptive loop filtering operation to ON is supplied, for example, the ON/OFF unit 511 sets the ON/OFF flag to the value indicating that the adaptive loop filtering operation is on, and supplies the ON/OFF flag to the filter coefficient calculation unit 512. When the ON/OFF information that sets the adaptive loop filtering operation to OFF is supplied, for example, the ON/OFF unit 511 sets the ON/OFF flag to the value indicating that the adaptive loop filtering operation is off, and supplies the ON/OFF flag to the filter coefficient calculation unit 512.

Other than the ON/OFF flag, an image subjected to a deblocking filtering operation is supplied to the filter coefficient calculation unit 512 from the deblocking filter 111. Further, an input image is supplied to the filter coefficient calculation unit 512 from the screen rearrangement buffer 102. Those images include at least portions to be subjected to the adaptive loop filtering operation.

When the ON/OFF flag supplied from the ON/OFF unit 511 is the value indicating that the adaptive loop filtering operation is on, the filter coefficient calculation unit 512 calculates the filter coefficient of the adaptive loop filtering operation, by using the image that has been subjected to the deblocking filtering operation and been supplied from the deblocking filter 111, and the input image obtained from the screen rearrangement buffer 102. The filter coefficient calculation unit 512 supplies the filter coefficient and the ON/OFF filter to the filtering unit 513.

When the ON/OFF flag supplied from the ON/OFF unit 511 is the value indicating that the adaptive loop filtering operation is off, on the other hand, the filter coefficient calculation unit 512 does not calculate a filter coefficient, and supplies only the ON/OFF flag indicating that the adaptive loop filtering operation is off, to the filtering unit 513.

When the ON/OFF flag supplied from the filter coefficient calculation unit 512 is the value indicating that the adaptive loop filtering operation is on, the filtering unit 513 performs the adaptive loop filtering operation on the image that has been subjected to the deblocking filtering operation and been supplied from the deblocking filter 111, by using the filter coefficient supplied from the filter coefficient calculation unit 512. The filtering unit 513 supplies and stores the filtering operation result into the frame memory 112.

When the ON/OFF flag supplied from the filter coefficient calculation unit 512 is the value indicating that the adaptive loop filtering operation is off, the filtering unit 513 does not perform the adaptive loop filtering operation, and supplies and stores the image that has been subjected to the deblocking filtering operation and been supplied from the deblocking filter 111, into the frame memory 112.

When the ON/OFF flag supplied from the ON/OFF unit 511 is the value indicating that the adaptive loop filtering operation is on, the filter coefficient calculation unit 512 supplies the calculated filter coefficient and the ON/OFF flag to the lossless encoding unit 106. When the ON/OFF flag supplied from the ON/OFF unit 511 is the value indicating that the adaptive loop filtering operation is off, the filter coefficient calculation unit 512 supplies only the ON/OFF flag to the lossless encoding unit 106.

### [ON/OFF Control Example 1]

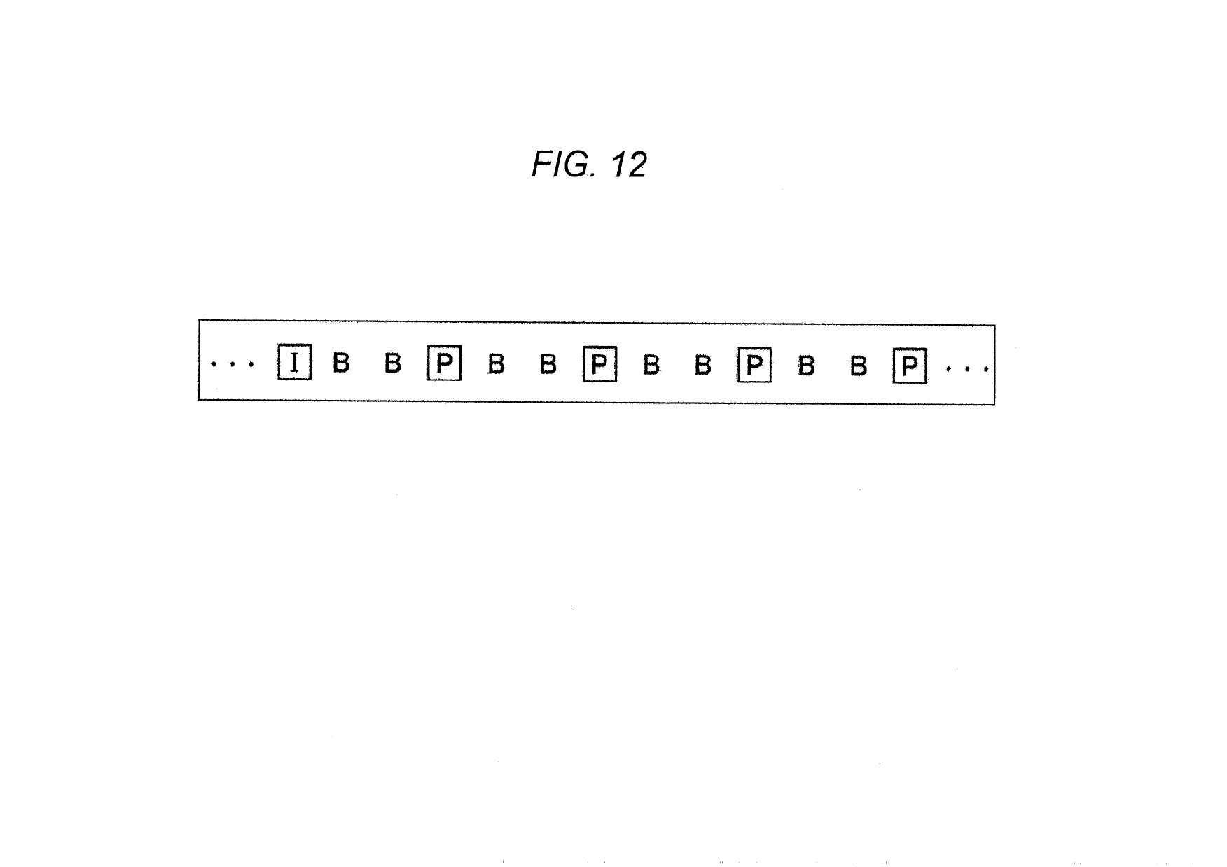

For example, pictures of respective types are processed in the sequence shown in FIG. 12 (from left to right, for example). Among those pictures, the filter control unit 501 processes I-pictures and P-pictures that are “images to be referred to” and are targets to be subjected to the adaptive loop filtering operation. Specifically, when a picture to be subjected to the adaptive loop filtering operation is an I-picture or a P-picture, the filter control unit 501 supplies the ON/OFF information setting the adaptive loop filtering operation to ON, to the ON/OFF unit 511. As for each of the B-pictures, the filter processing unit 501 supplies the ON/OFF information setting the adaptive loop filtering operation to OFF, to the ON/OFF unit 511.

By the method disclosed in Non-Patent Document 1, adaptive loop filtering is performed on all pictures or slices. On the other hand, the filter control unit 501 controls whether to perform adaptive loop filtering for each predetermined image unit.

In the adaptive loop filtering operation, an optimum filter coefficient needs to be calculated with a Wiener filter, which requires an enormous amount of calculation. Therefore, by the method disclosed in Non-Patent Document 1, optimum filter coefficients need to be calculated for all the images (pictures or slices). Therefore, the amount of calculation dramatically increases, and the image encoding operation load might become extremely large.

However, if the entire adaptive loop filtering operation is simply skipped, image deterioration might become more conspicuous in decoded images than in cases where the adaptive loop filtering operation is performed.

Originally, the role of an adaptive loop filter is to increase the image quality of decoded images, and also increase the efficiency in predicting images by referring to the decoded images. That is, the effect of an adaptive loop filter for an image to be a reference (an image to be referred to) has a larger influence on the image quality of the entire sequence than the effect of an adaptive loop filter for an image that is not a reference.

In view of this, the filter control unit 501 controls the operation of the adaptive loop filter 502 to perform the adaptive loop filtering only on images (such as pictures or slices) to be referred to in the sequence, and not to perform the adaptive loop filtering on images (such as pictures and slices) that are not to be referred to.

By performing control so as to skip the adaptive loop filtering operation on images having small influences on decoded images in the above manner, the image encoding device 500 can dramatically reduce the amount of calculation in the filter coefficient calculation and the like while restraining image quality deterioration in the decoded images. In other words, by performing the adaptive loop filtering operation only on images to be greatly affected by the filtering operation, the image encoding device 500 can increase the image quality of decoded images while restraining an unnecessary increase in the load.

It should be noted that the picture sequence shown in FIG. 12 is merely an example, and this technique can also be applied to any other sequence than that.

### [ON/OFF Control Example 2]

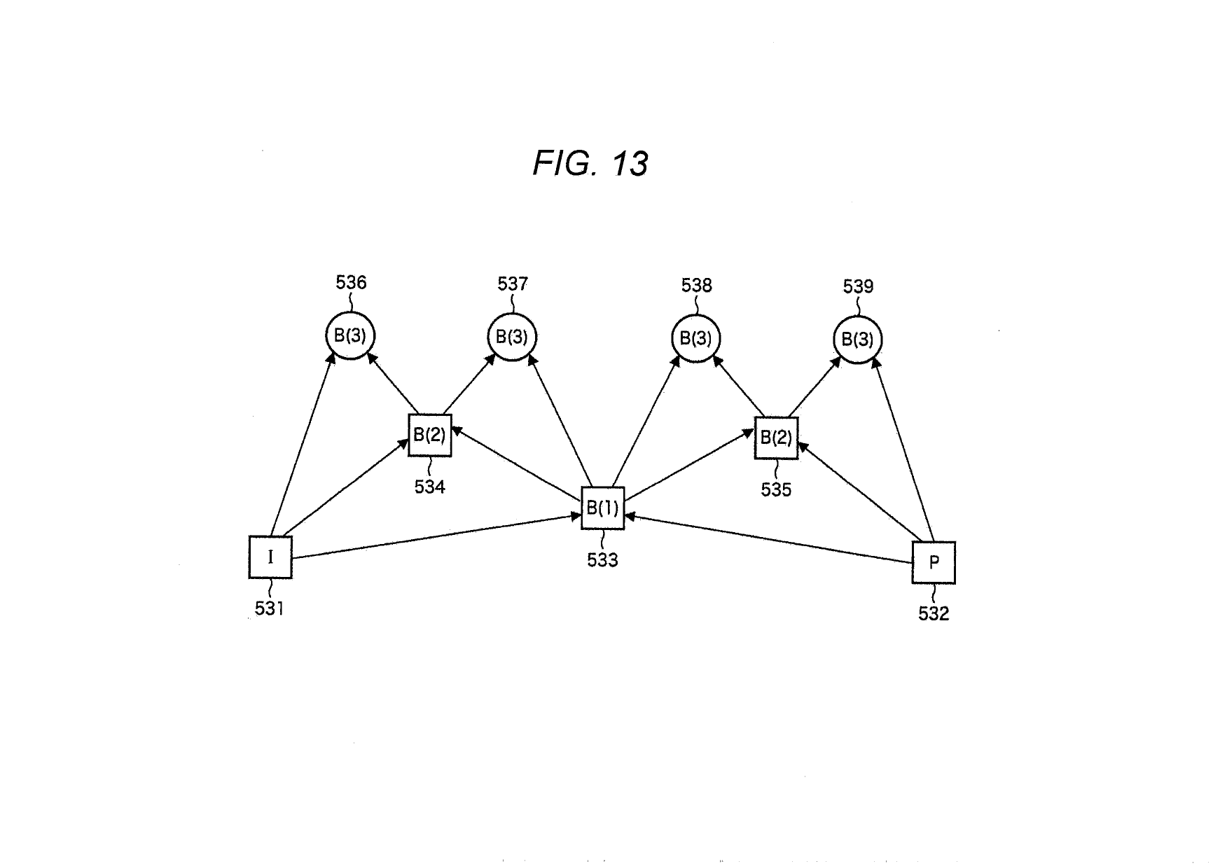

FIG. 13 is a diagram showing an example of a GOP (Group of Picture) structure formed with hierarchical B-pictures.

As shown in FIG. 13, B-pictures are arranged in hierarchical levels in this case. In FIG. 13, the B-pictures are hierarchized from bottom to top. That is, the B-picture in the lowermost level forms a first hierarchical level, the B-pictures in the middle level form a second hierarchical level, and the B-pictures in the uppermost level form a third hierarchical level. The numbers in the parentheses of B(n) indicate hierarchical numbers. Specifically, B(1) indicates the B-picture of the first hierarchical level, B(2) indicates the B-pictures of the second hierarchical level, and B(3) indicates the B-pictures of the third hierarchical level.

The arrows indicate the reference relationships. Referencing is performed in the directions indicated by the arrows. Specifically, the B-pictures (B(3)) of the third hierarchical level refer to the B-pictures (B(2)) of the second hierarchical level, the I-picture, the P-picture, or the B-picture (B(1)) of the first hierarchical level. The B-pictures (B(2)) of the second hierarchical level refer to the B-picture (B(1)) of the first hierarchical level, the I-picture, or the P-picture. The B-picture (B(1)) of the first hierarchical level does not refer to any other B-picture, and refers only to the I-picture and the P-picture.

More specifically, the B-picture 533 of the first hierarchical level refers to the I-picture 531 and the P-picture 532. The B-picture 534 of the second hierarchical level refers to the I-picture 531 and the B-picture 533, and the B-picture 535 refers to the B-picture 533 and the P-picture 532.

Further, the B-picture 536 of the third hierarchical level refers to the I-picture 531 and the B-picture 534, the B-picture 537 refers to the B-picture 533 and the B-picture 534, the B-picture 538 refers to the B-picture 533 and the B-picture 535, and the B-picture 539 refers to the B-picture 535 and the P-picture 532.

The number of hierarchical levels, the hierarchical structure, the layout of respective pictures, and the reference relationships among the respective pictures can of course be arbitrarily set, and may not be the same as the pattern shown in FIG. 13.

For an image having such a GOP structure, the filter control unit 501 sets “images to be referred to” that are the pictures other than the B-pictures of the third hierarchical level, or are the B-pictures of the second hierarchical level, the B-picture of the first hierarchical level, the I-picture, and the P-picture.

As in the case shown in FIG. 12, the method of determining which images are the “images to be referred to” may be any method other than the above described method.

For example, the B-picture of the first hierarchical level, the I-picture, and the P-picture may be set as the “images to be referred to”. Alternatively, the I-picture and the P-picture may be set as the “images to be referred to”. Only the I-picture or the P-picture may be set as the “image to be referred to”.

In this case, a check can be made to determine whether an image is an “image to be referred to”, based on the information indicating the type of each predetermined unit image, as in the case shown in FIG. 12. For example, a check may be made to determine whether a slice is an “image to be referred to”, based on the slice type. Alternatively, the operation of the adaptive loop filter may be controlled by some other unit.

The GOP structure using hierarchical B-pictures as shown in FIG. 13 is suited to particular speed reproduction (trick play) such as fast-forwarding and rewinding. For example, octa-speed decoding can be realized by decoding only the I-picture and the P-picture, quad-speed decoding can be realized by further decoding the B-picture of the first hierarchical level, and double-speed decoding can be realized by further decoding the B-pictures of the second hierarchical level.

As the filter control unit 501 controls the operation of the adaptive loop filter in the above described manner, excellent image quality of the pictures to be displayed through such high-speed decoding can be maintained by the filtering operation performed by the adaptive loop filter 502. That is, the filter control unit 501 can perform filter control suitable for high-speed decoding.

### [Image Types]

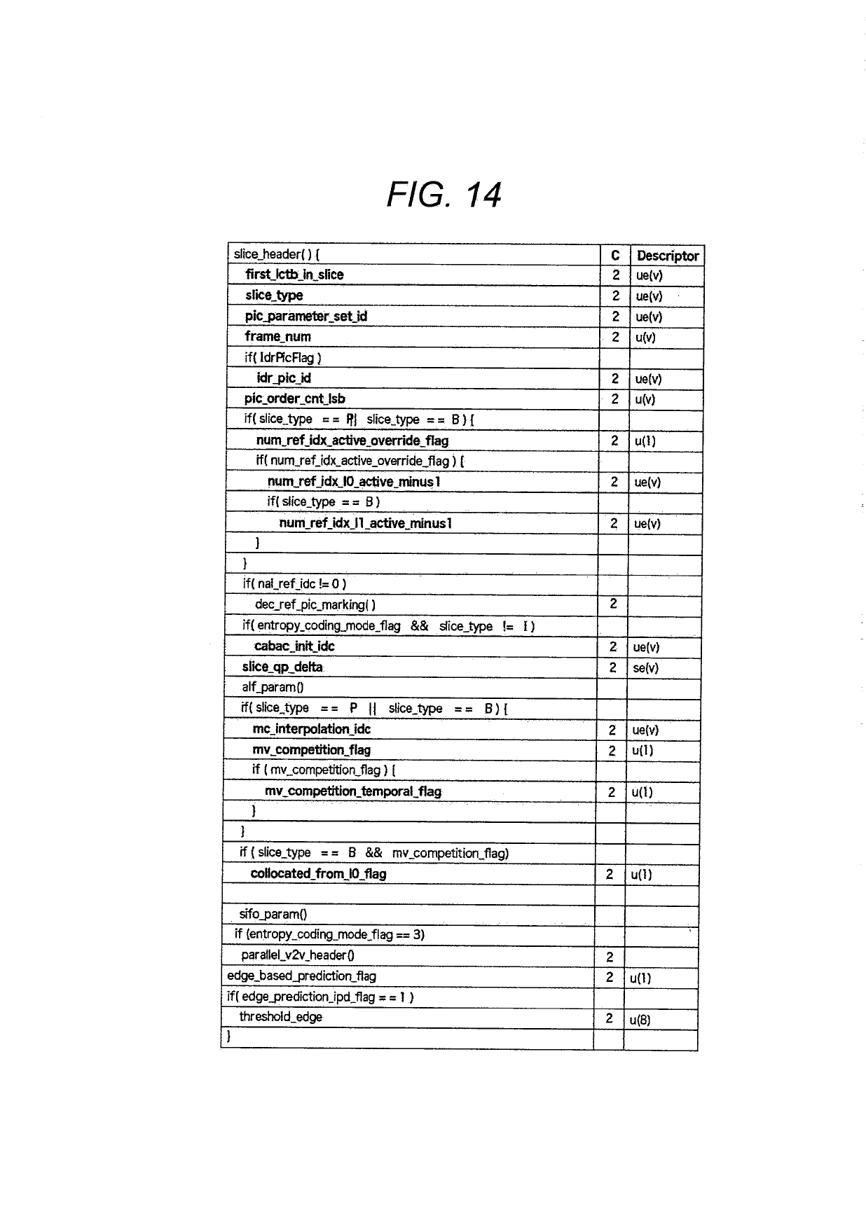

As described above, the filter control unit 501 controls the operation of the adaptive loop filter 502 in accordance with types of images. FIG. 14 shows an exemplary syntax of a slice header. As shown in FIG. 14, in a slice header, a slice type (slice tupe) indicating the type (such as I, P, or B) of the slice is written. For example, the filter control unit 501 obtains the slice header of an input image from the screen rearrangement buffer 102, and, based on the information (the slice type) written in the slice header, determines the type of the image.

It should be noted that the information about the type of the image may be written in a portion other than the slice header. For example, the information indicating the picture type may be written in picture parameter set information. In that case, the filter control unit 501 obtains the picture parameter set information about an input image from the screen rearrangement buffer 102, and, determines the type of the image, based on the value of the information indicating the picture type written therein.

It should be noted that the slice header, the picture parameter set information, or the like may be contained beforehand in the data of an input image, or may be generated at the screen rearrangement buffer 102 or the like.

Based on the information indicating the types of images, the filter control unit 501 can readily control the operation of the adaptive loop filter 502.

### [ON/OFF Flag]

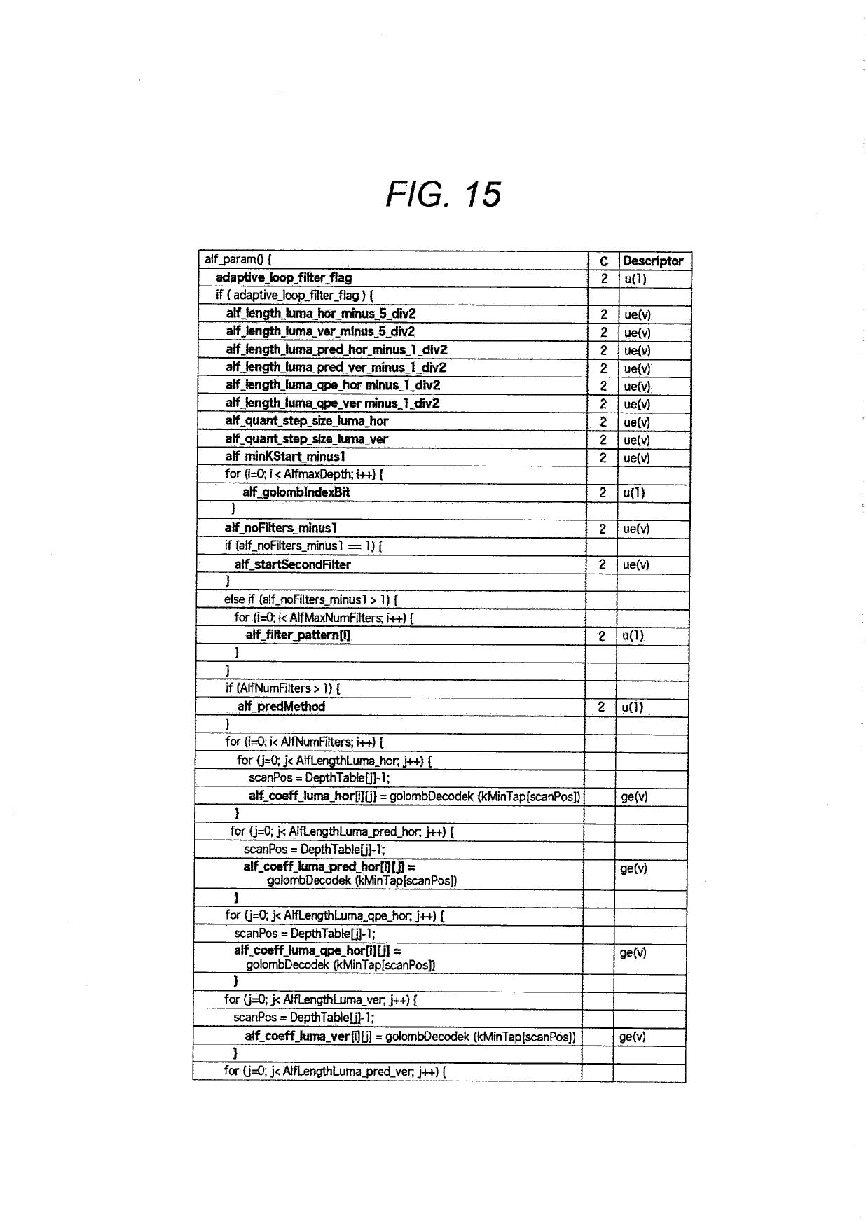

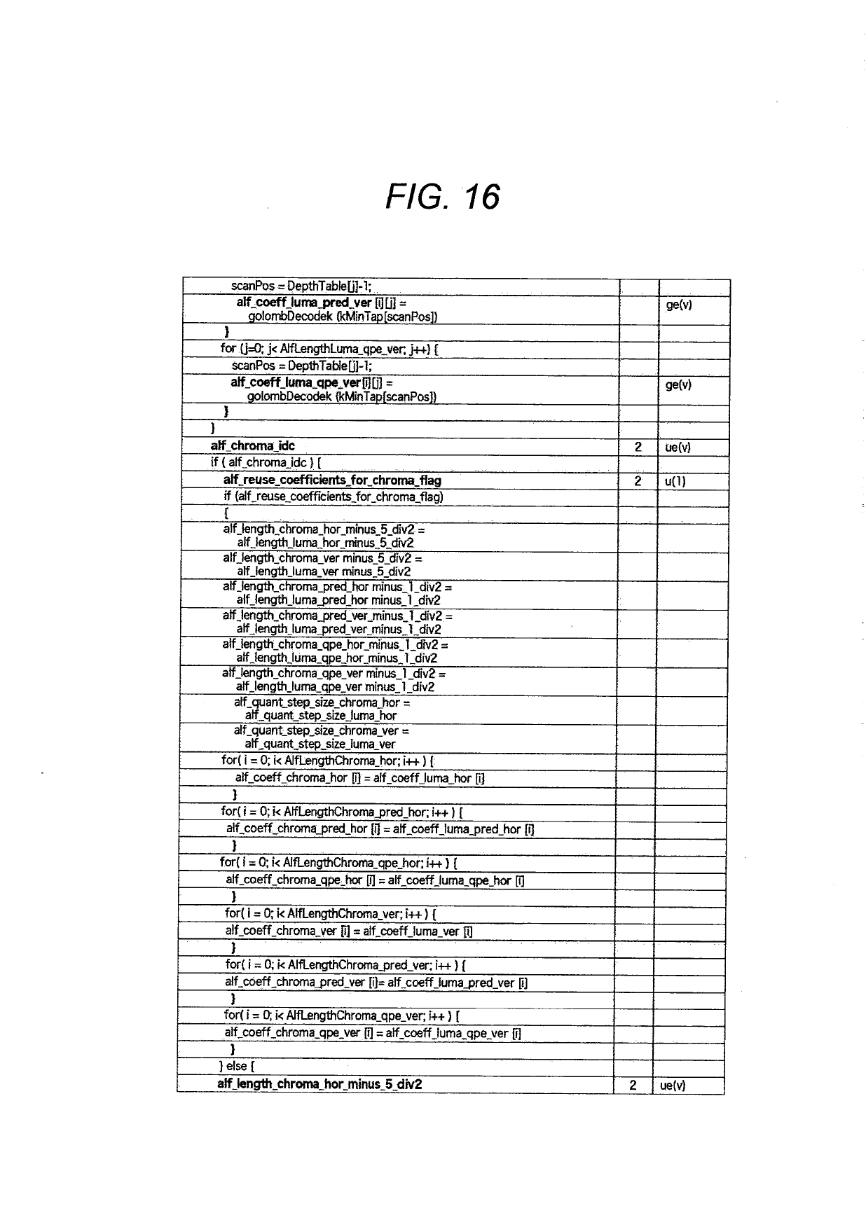

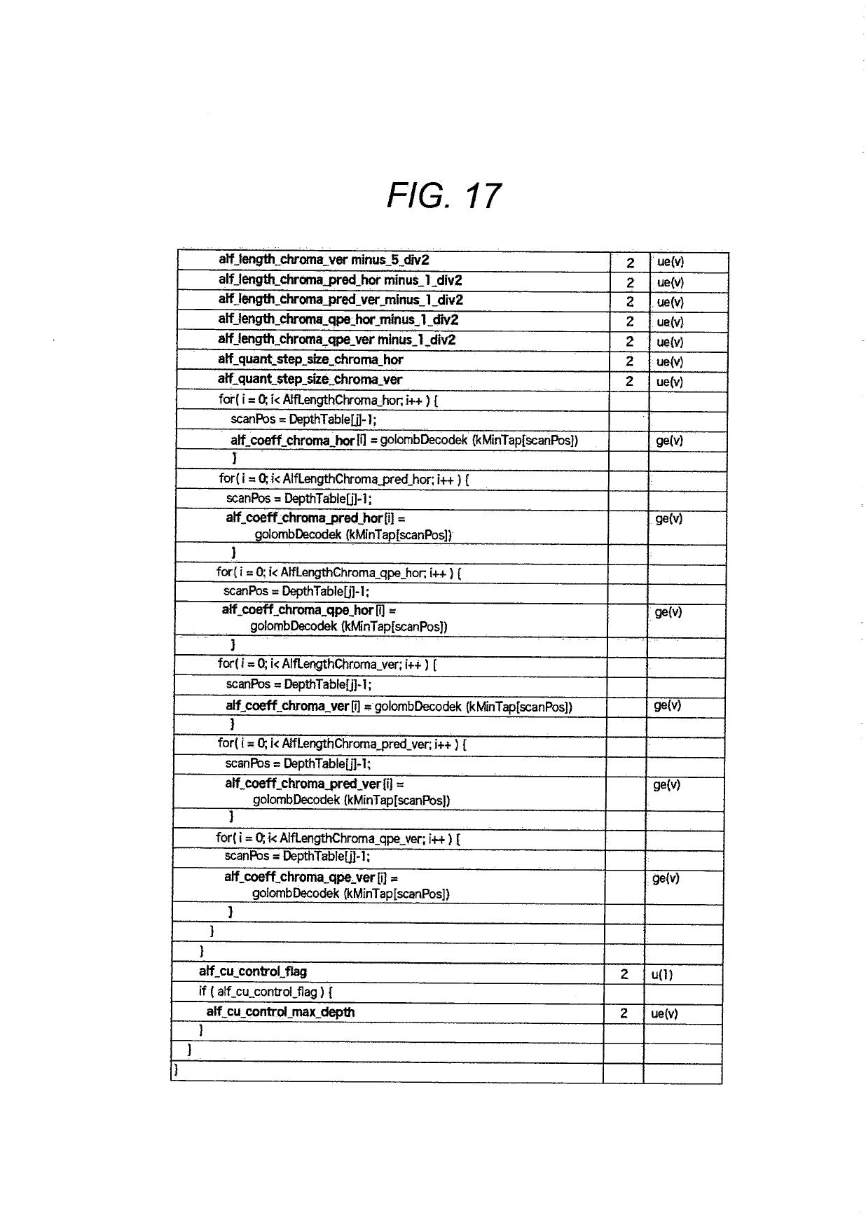

As described above, the filter coefficient calculation unit 512 supplies the ON/OFF flag (as well as a filter coefficient, if there is a filter coefficient calculated) to the lossless encoding unit 106. FIGS. 15 through 17 are diagrams indicating the syntax of flag information about the adaptive loop filter.

For example, the lossless encoding unit 106 sets the ON/OFF flag supplied from the filter coefficient calculation unit 512 as an adaptive loop filter flag (adaptive_loop_filter_flag) to encoded data (FIG. 15). Where a filter coefficient has been supplied, the lossless encoding unit 106 also encodes the filter coefficient, and adds the filter coefficient to the encoded data (FIGS. 15 through 17).

In this manner, the ON/OFF flag and the filter coefficient of the adaptive loop filtering operation are supplied to an image decoding device.

The above described information such as the ON/OFF flag and the filter coefficient may be added to a portion of encoded data, or may be transmitted to the decoding end independently of the encoded data. For example, the lossless encoding unit 106 may write those pieces of information as a syntax in a bit stream. Alternatively, the lossless encoding unit 106 may store those pieces of information as auxiliary information into a predetermined region, and then transmit the information. For example, those pieces of information may be stored in a parameter set (such as a sequence or the header of a picture) of SEI (Supplemental Enhancement Information) or the like.

Alternatively, the lossless encoding unit 106 may transmit those pieces of information (as a separate file) to an image decoding device independently of the encoded data. In that case, the correspondence relationship between those pieces of information and the encoded data needs to be clarified (so as to be recognized at the decoding end), but any method may be used in doing so. For example, table information indicating the correspondence relationship may be created, or link information indicating the data of correspondence may be embedded in the data at either end.

### [Encoding Operation Flow]

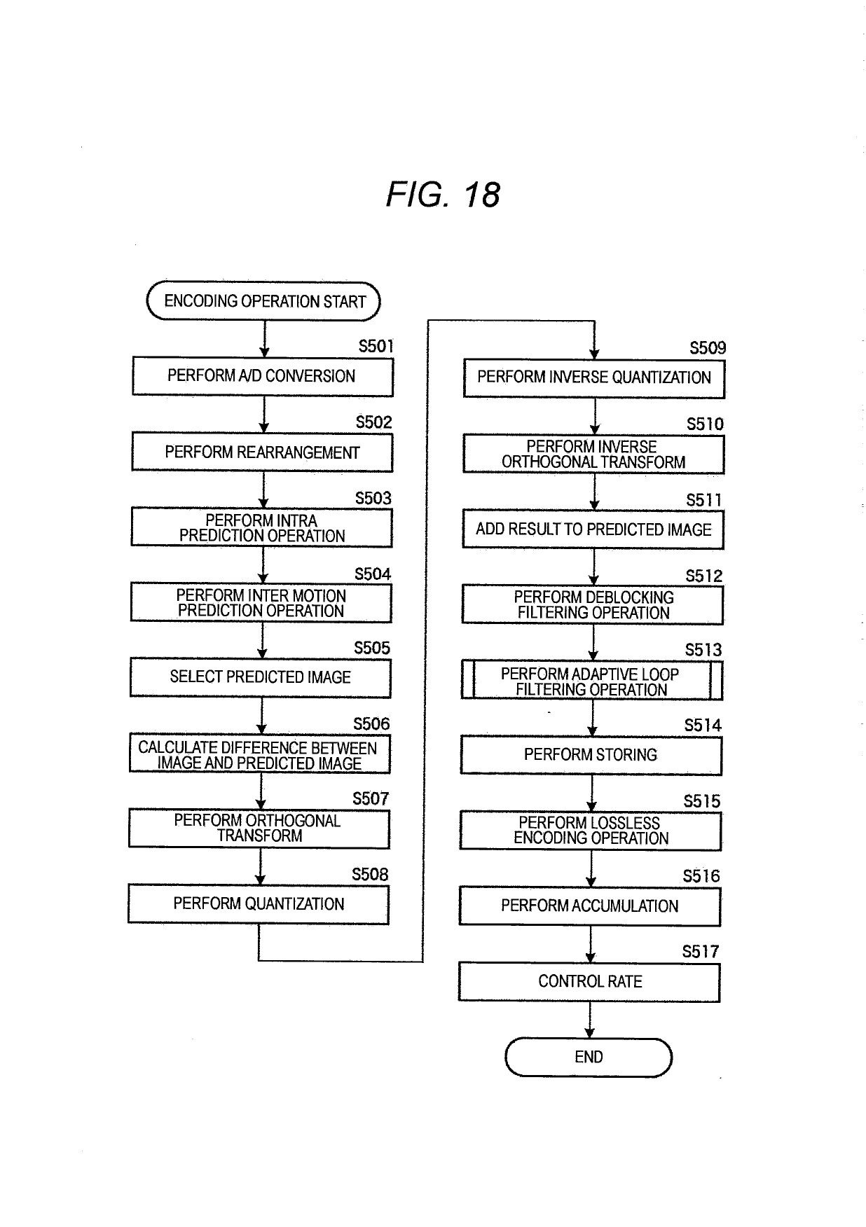

Referring now to the flowchart in FIG. 18, an example of the flow of an encoding operation to be performed by the image encoding device 500 of FIG. 10 is described.

After an encoding operation is started, the A/D converter 101 performs an A/D conversion on an input image in step S501. In step S502, the screen rearrangement buffer 102 stores images supplied from the A/D converter 101, and rearranges the respective pictures in encoding order, instead of display order.

When a current image that has been supplied from the screen rearrangement buffer 102 is an image of a block to be intra-processed, a decoded image to be referred to is read from the frame memory 112, and is supplied to the intra prediction unit 114 via the selection unit 113.

Based on those images, the intra prediction unit 114 performs intra predictions on the pixels of the current block in all candidate intra prediction modes in step S503. The decoded pixels to be referred to are pixels that have not been subjected to filtering by the deblocking filter 111 and the adaptive loop filter 502.

Through the procedure of step S503, intra predictions are performed in all the candidate intra prediction modes, and cost function values are calculated in all the candidate intra prediction modes. Based on the calculated cost functions values, an optimum intra prediction mode is selected, and a predicted image generated through an intra prediction in the optimum intra prediction mode and the cost function value thereof are supplied to the selection unit 116.

When a current image that has been supplied from the screen rearrangement buffer 102 is an image to be inter-processed, an image to be referred to is read from the frame memory 112, and is supplied to the motion prediction/compensation unit 115 via the selection unit 113. Based on those images, the motion prediction/compensation unit 115 performs an inter motion predicting operation in step S504.

Through the procedure of step S504, motion predicting operations are performed in all candidate inter prediction modes, and cost functions values are calculated in all the candidate inter prediction modes. Based on the calculated cost function values, an optimum inter prediction mode is determined. The predicted image generated in the optimum inter prediction mode and the cost function value thereof are supplied to the selection unit 116.

In step S505, based on the respective cost function values output from the intra prediction unit 114 and the motion prediction/compensation unit 115, the selection unit 116 determines an optimum prediction mode that is either the optimum intra prediction mode or the optimum inter prediction mode. The selection unit 116 selects the predicted image generated in the determined optimum prediction mode, and supplies the selected predicted image to the arithmetic operation unit 103 and the arithmetic operation unit 110. This predicted image is to be used in the later described arithmetic operations in step S506 and step S511.

The selection information about this predicted image is supplied to the intra prediction unit 114 or the motion prediction/compensation unit 115. When the predicted image generated in the optimum intra prediction mode is selected, the intra prediction unit 114 supplies the information indicating the optimum intra prediction mode (or intra prediction mode information) to the lossless encoding unit 106.

When the predicted image generated in the optimum inter prediction mode is selected, the motion prediction/compensation unit 115 outputs the information indicating the optimum inter prediction mode, as well as information according to the optimum inter prediction mode, if necessary, to the lossless encoding unit 106. The information according to the optimum inter prediction mode may be motion vector information, reference frame information, or the like.

In step S506, the arithmetic operation unit 103 calculates the difference between the images rearranged in step S502 and the predicted image selected in step S505. The predicted image is supplied to the arithmetic operation unit 103 via the selection unit 116 from the motion prediction/compensation unit 115 when an inter prediction is performed, and from the intra prediction unit 114 when an intra prediction is performed.

The data amount of the difference data is smaller than that of the original image data. Accordingly, the data amount can be made smaller than in a case where images are directly encoded.

In step S507, the orthogonal transform unit 104 performs an orthogonal transform on the difference information supplied from the arithmetic operation unit 103. Specifically, orthogonal transforms such as discrete cosine transforms or Karhunen-Loeve transforms are performed, and a transform coefficient is output.

In step S508, the quantization unit 105 quantizes the transform coefficient. In this quantization, rate control is performed as will be described later in the description of step S517.

The difference information quantized in the above manner is locally decoded in the following manner. Specifically, in step S509, the inverse quantization unit 108 inversely quantizes the transform coefficient quantized by the quantization unit 105, having characteristics compatible with the characteristics of the quantization unit 105. In step S510, the inverse orthogonal transform unit 109 performs an inverse orthogonal transform on the transform coefficient inversely quantized by the inverse quantization unit 108, having characteristics compatible with the characteristics of the orthogonal transform unit 104.

In step S511, the arithmetic operation unit 110 adds the predicted image input via the selection unit 116 to the locally decoded difference information, to generate a locally decoded image (an image corresponding to the input to the arithmetic operation unit 103).

In step S512, the deblocking filter 111 performs a deblocking filtering operation on the image output from the arithmetic operation unit 110. Through this, block distortions are removed. The decoded image from the deblocking filter 111 is output to the adaptive loop filter 502.

In step S513, the filter control unit 501 and the adaptive loop filter 502 perform an adaptive loop filtering operation, if necessary, on the image subjected to the deblocking filtering operation in step S512. The adaptive loop filtering operation will be described later in detail.

In step S514, the frame memory 112 stores the image that has been filtered as appropriate in step S513. It should be noted that images that have not been subjected to filtering operations by the deblocking filter 111 and the adaptive loop filter 502 are also supplied from the arithmetic operation unit 110, and are stored into the frame memory 112.

Meanwhile, the transform coefficient quantized in step S508 is also supplied to the lossless encoding unit 106. In step S515, the lossless encoding unit 106 encodes the quantized transform coefficient that has been output from the quantization unit 105. That is, the difference image is subjected to lossless encoding such as variable-length encoding or arithmetic encoding, and is compressed.

At the lossless encoding unit 106, the input ON/OFF flag, the adaptive filter coefficient, and the intra prediction mode information or the information according to the optimum inter prediction mode are encoded, and are added to the header information.

For example, the information indicating an intra prediction mode is encoded for each macroblock. The motion vector information and the reference frame information are encoded for each block being processed. The filter coefficient and the ON/OFF flag are encoded for each slice or each picture parameter set.

In step S516, the accumulation buffer 107 stores the difference image as a compressed image. The compressed image stored in the accumulation buffer 107 is read out when necessary, and is transmitted to the decoding end via a transmission path (not shown).

In step S517, based on the compressed image stored in the accumulation buffer 107, the rate control unit 117 controls the quantizing operation rate of the quantization unit 105 so as not to cause an overflow or underflow.

### [Flow of the Adaptive Loop Filtering Operation]

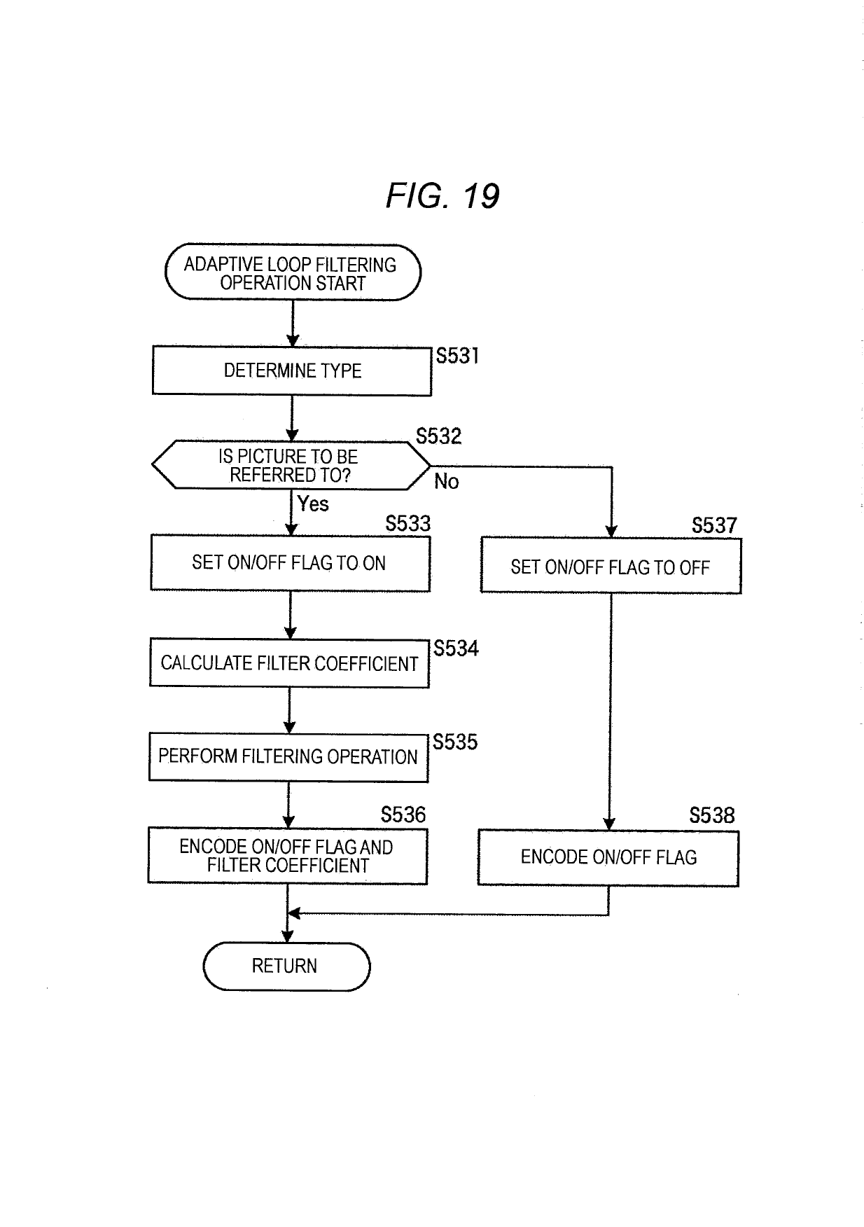

Referring now to the flowchart in FIG. 19, an example of the flow of the adaptive loop filtering operation performed in step S513 of FIG. 18 is described in detail.

When the adaptive loop filtering operation is started, the filter control unit 501 determines the type of the image being subjected to the adaptive loop filtering operation in step S531. In step S532, the filter control unit 501 determines whether the image being subjected to the adaptive loop filtering operation is an image to be referred to. When the result of the type determination in step S531 shows that the image is an image to be referred to, the filter control unit 501 moves on to step S533.

In step S533, the ON/OFF unit 511 sets the ON/OFF flag to ON. In step S534, based on the image subjected to the deblocking filtering operation and the input image, the filter coefficient calculation unit 512 calculates an appropriate filter coefficient. In step S535, the filtering unit 513 performs the adaptive loop filtering operation on the image subjected to the deblocking filtering operation, by using the filter coefficient calculated in step S534.

In step S536, the filtering unit 513 supplies the ON/OFF flag and the filter coefficient used as described above to the lossless encoding unit 106, which then encodes the ON/OFF flag and the filter coefficient.

After ending the procedure of step S536, the adaptive loop filter 502 ends the adaptive loop filtering operation. The operation then returns to step S513 of FIG. 18, and the procedures of step S514 and thereafter are carried out.

When it is determined in step S532 of FIG. 19 that the image being subjected to the adaptive loop filtering operation is not an image to be referred to, the filter control unit 501 moves on to step S537.

In step S537, the ON/OFF unit 511 sets the ON/OFF flag to OFF. In step S538, the filtering unit 513 supplies the ON/OFF flag that has been set as described above, to the lossless encoding unit 106, which then encodes the ON/OFF flag.

After ending the procedure of step S538, the adaptive loop filter 502 ends the adaptive loop filtering operation. The operation then returns to step S513 of FIG. 18, and the procedures of step S514 and thereafter are carried out.

In the above manner, the filter control unit 501 can readily control the operation of the adaptive loop filter 502. Also, as the filter control unit 501 controls the operation of the adaptive loop filter 502 in accordance with the type of the image, the image encoding device 500 can reduce the encoding operation load while restraining image quality deterioration in decoded images.

Encoded data that has been generated and output by the image encoding device 500 as described above can be decoded in the same manner as a conventional manner (in the same manner as in a case where encoded data generated by the image encoding device 300 is decoded) by a conventional image decoding device (such as the image decoding device 400 that is disclosed in Non-Patent Document 1 and has been described with reference to FIG. 9).

That is, using the information added to encoded data, such as the adaptive loop filter flag (adaptive_loop_filter_flag) and the filter coefficient, the loop filter 401 performs the adaptive loop filtering operation, where appropriate, on the image subjected to the deblocking filtering operation by the deblocking filter 206. In this manner, the image decoding device 400 can restrain image quality deterioration in decoded images.

### 2. Second Embodiment

### Another Example of an Image Encoding Device

Although the ON/OFF control performed by the adaptive loop filter in accordance with the type of an image has been described above, the invention is not limited to that, and the number of taps of an adaptive loop filter may be controlled in accordance with the type of an image.

Specifically, in an adaptive loop filtering operation, the tap length may be changed in accordance with the type of an image, such as a picture type or a slice type. For example, in an adaptive loop filtering operation, a longer tap length may be used for a picture to be referred to, and a shorter tap length may be used for a picture not to be referred to.

According to the method disclosed in Non-Patent Document 1, adaptive loop filtering operations are performed for all predetermined tap lengths, such as five taps, seven taps, and nine taps, and the filtering operation result with the optimum tap length is selected in accordance with the costs of the respective operation results.

At this point, the tap lengths may be shortened by performing filtering operations, with some of the respective coefficients being reduced to zero. For example, in a 9-tap filtering operation, the first coefficient and the ninth coefficient (the coefficients at both ends) are reduced to zero (0), to substantially shorten the tap length (to seven taps). The tap lengths can also be shortened in a 5-tap filtering operation and a 7-tap filtering operation in the same manner as above. The number of coefficients to be reduced to zero is of course arbitrarily determined. Also, it is possible to arbitrarily determine which coefficient(s) is (are) to be reduced zero.

As the tap length in an adaptive loop filtering operation for an image not to be referred to is shortened as described above, the amount of calculation can be reduced. In this case, a filtering operation is performed, though the tap length is shortened. Accordingly, the adverse influence on the image quality of decoded images can be made smaller than that in the first embodiment. That is, image quality deterioration in decoded image can be more effectively restrained than in the first embodiment.

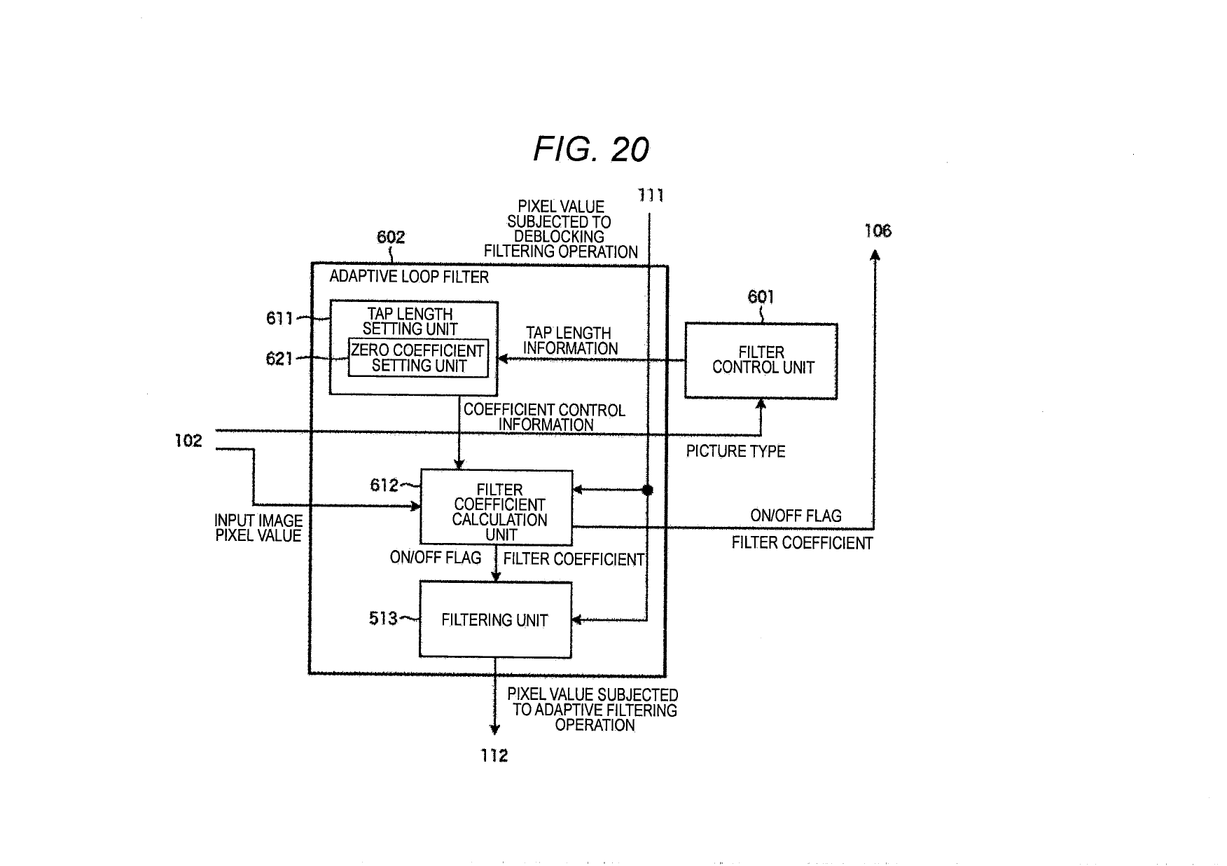

FIG. 20 is a block diagram showing exemplary structures of the filter control unit and the adaptive loop filter used in that case.

As shown in FIG. 20, the image encoding device 500 in this case includes a filter control unit 601 in place of the filter control unit 501, and an adaptive loop filter 602 in place of the adaptive loop filter 502.

While the filter control unit 501 controls switching on/off of the adaptive loop filtering operation of the adaptive loop filter 502 in accordance with the type of the image being subjected to the adaptive loop filtering operation, the filter control unit 601 controls the tap length in the adaptive loop filtering operation of the adaptive loop filter 602 in accordance with the type of the image being subjected to the adaptive loop filtering operation.

More specifically, based on the information indicating a picture type (or a slice type) supplied from the screen rearrangement buffer 102, the filter control unit 601 determines whether the image being subjected to the adaptive loop filtering operation is an “image to be referred to”. When the image being subjected to the adaptive loop filtering operation is not an “image to be referred to”, the filter control unit 601 controls the operation of the adaptive loop filter 602 so as to shorten the tap length.

The filter control unit 601 supplies tap length information designating a tap length to a tap length setting unit 611 of the adaptive loop filter 602.

Under the control of the filter control unit 601, the adaptive loop filter 602 performs the adaptive loop filtering operation with the tap length that has been set in accordance with the type of the image being subjected to the filtering operation.

The adaptive loop filter 602 includes the tap length setting unit 611, a filter coefficient calculation unit 612, and a filtering unit 513.

The tap length setting unit 611 generates coefficient control information that is control information to issue an instruction to calculate a filter coefficient of the tap length designated by the tap length information supplied from the filter control unit 601, and supplies the coefficient control information to the filter coefficient calculation unit 612.

That is, when the image being subjected to the adaptive loop filtering operation is not an “image to be referred to” as described above, the tap length setting unit 611 generates coefficient control information so as to shorten the tap length, and supplies the coefficient control information to the filter coefficient calculation unit 612. In other words, when the image being subjected to the adaptive loop filtering operation is an “image to be referred to”, the tap length setting unit 611 generates coefficient control information so as to increase the tap length, and supplies the coefficient control information to the filter coefficient calculation unit 612.

The tap length setting unit 611 includes a zero coefficient setting unit 621. The zero coefficient setting unit 621 sets the value of some of filter coefficients calculated by the filter coefficient calculation unit 612, to zero. That is, the tap length setting unit 611 generates the coefficient control information designating zero as the value of some of the filter coefficients calculated by the filter coefficient calculation unit 612. In this case, as some coefficients are set to zero, a desired tap length is realized.

For example, when the filter coefficient calculation unit 612 calculates filter coefficients of nine taps, the zero coefficient setting unit 621 sets the first coefficient and the ninth coefficient of the nine taps to zero. In this case, the coefficient control information designates seven taps. The filter coefficient calculation unit 612 sets the values of the coefficients designated by the coefficient control information to zero, and calculates the other coefficients. As a result, the filter coefficient calculation unit 612 calculates the filter coefficients of the seven taps.

The filter coefficient calculation unit 612 supplies the calculated filter coefficients to the filtering unit 513. In this case, the filter coefficient calculation unit 612 generates an ON/OFF flag having the value of ON, and supplies the ON/OFF flag to the filtering unit 513.

Using the filter coefficients supplied from the filter coefficient calculation unit 612, the filtering unit 513 performs the adaptive loop filtering operation on the image that has been subjected to the deblocking filtering operation and been supplied from the deblocking filter 111.

In this case, the filtering unit 513 supplies and stores the image subjected to the adaptive loop filtering operation into the frame memory 112. The filter coefficient calculation unit 612 supplies the calculated filter coefficients and the ON/OFF flag having the value of ON to the lossless encoding unit 106, which encodes the filter coefficients and the ON/OFF flag.

The encoding operation in this case is performed in the same manner as in the case described with reference to the flowchart in FIG. 18.

### [Flow of the Adaptive Loop Filtering Operation]

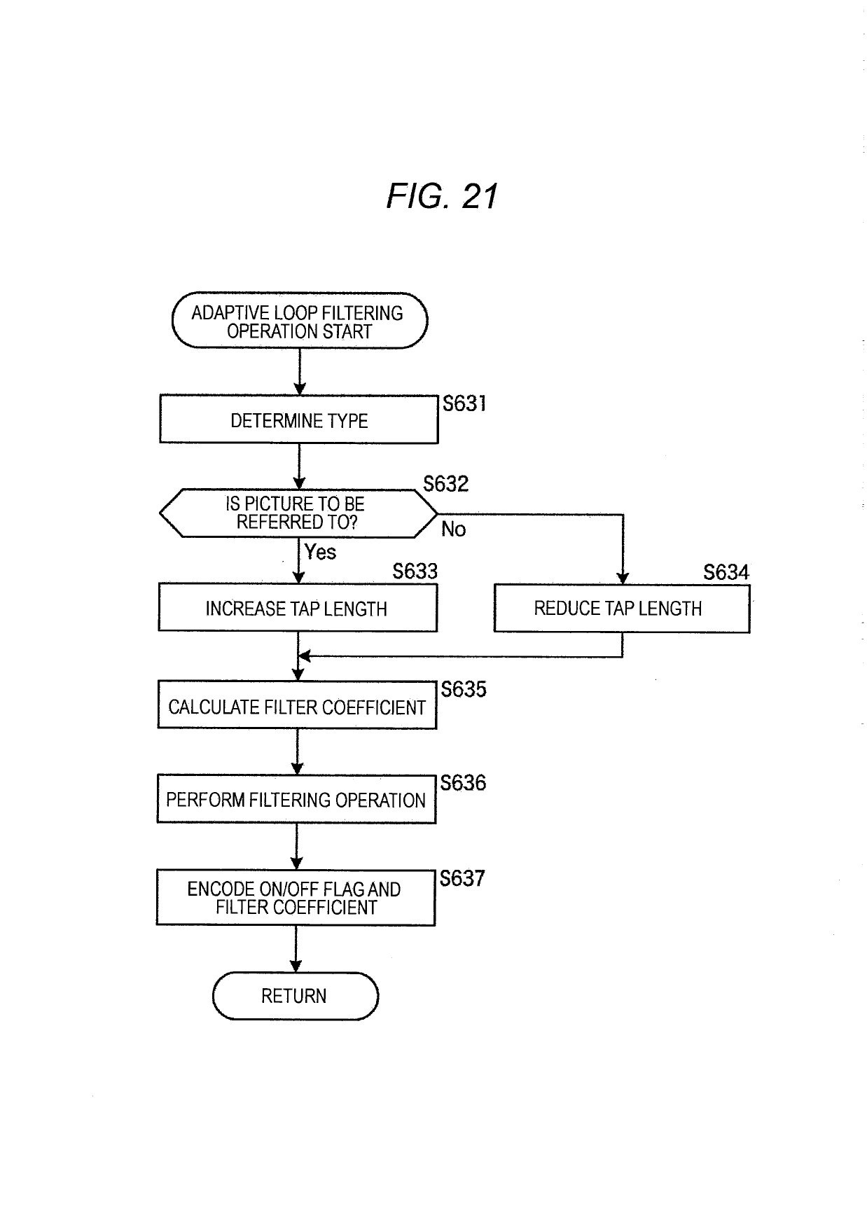

Referring now to the flowchart in FIG. 21, an example of the flow of the adaptive loop filtering operation to be performed in this case is described. This flowchart is equivalent to the flowchart in FIG. 19.

When the adaptive loop filtering operation is started, the filter control unit 601 determines the type of the image being subjected to the adaptive loop filtering operation in step S631.

In step S632, the filter control unit 601 determines whether the image being subjected to the adaptive loop filtering operation is an image to be referred to. When the result of the type determination in step S631 shows that the image is an image to be referred to, the filter control unit 601 moves on to step S633. In step S633, the tap length setting unit 611 performs control so as to increase the filter coefficient tap length, and the operation moves on to step S635.

When it is determined in step S632 that the image being subjected to the adaptive loop filtering operation is not an image to be referred to, the filter control unit 601 moves on to step S634. In step S634, the tap length setting unit 611 performs control so as to shorten the filter coefficient tap length, and the operation moves on to step S635.

In step S635, based on the image subjected to the deblocking filtering operation and the input image, the filter coefficient calculation unit 612 calculates appropriate filter coefficients. The filter coefficient calculation unit 612 generates the ON/OFF flag having the value of ON. In step S636, the filtering unit 513 performs the adaptive loop filtering operation on the image subjected to the deblocking filtering operation, by using the filter coefficients calculated in step S635.

In step S637, the filtering unit 513 supplies the ON/OFF flag and the filter coefficients used as described above to the lossless encoding unit 106, which then encodes the ON/OFF flag and the filter coefficients.

After ending the procedure of step S637, the adaptive loop filter 602 ends the adaptive loop filtering operation. The operation then returns to step S513 of FIG. 18, and the procedures of step S514 and thereafter are carried out.

In the above manner, the filter control unit 601 can readily control the operation of the adaptive loop filter 602. Also, as the filter control unit 601 controls the tap length in the filtering operation of the adaptive loop filter 602 in accordance with the type of the image, the image encoding device 500 can reduce the encoding operation load while restraining image quality deterioration in decoded images.

In this case, encoded data that has been generated and output by the image encoding device 500 as described above can also be decoded in the same manner as a conventional manner (in the same manner as in a case where encoded data generated by the image encoding device 300 is decoded) by a conventional image decoding device (such as the image decoding device 400 that is disclosed in Non-Patent Document 1 and has been described with reference to FIG. 9).

That is, using the information added to encoded data, such as the adaptive loop filter flag (adaptive_loop_filter_flag) and the filter coefficients, the loop filter 401 performs the adaptive loop filtering operation, where appropriate, on the image subjected to the deblocking filtering operation by the deblocking filter 206. In this manner, the image decoding device 400 can restrain image quality deterioration in decoded images.

### [Example of an Extended Macroblock]

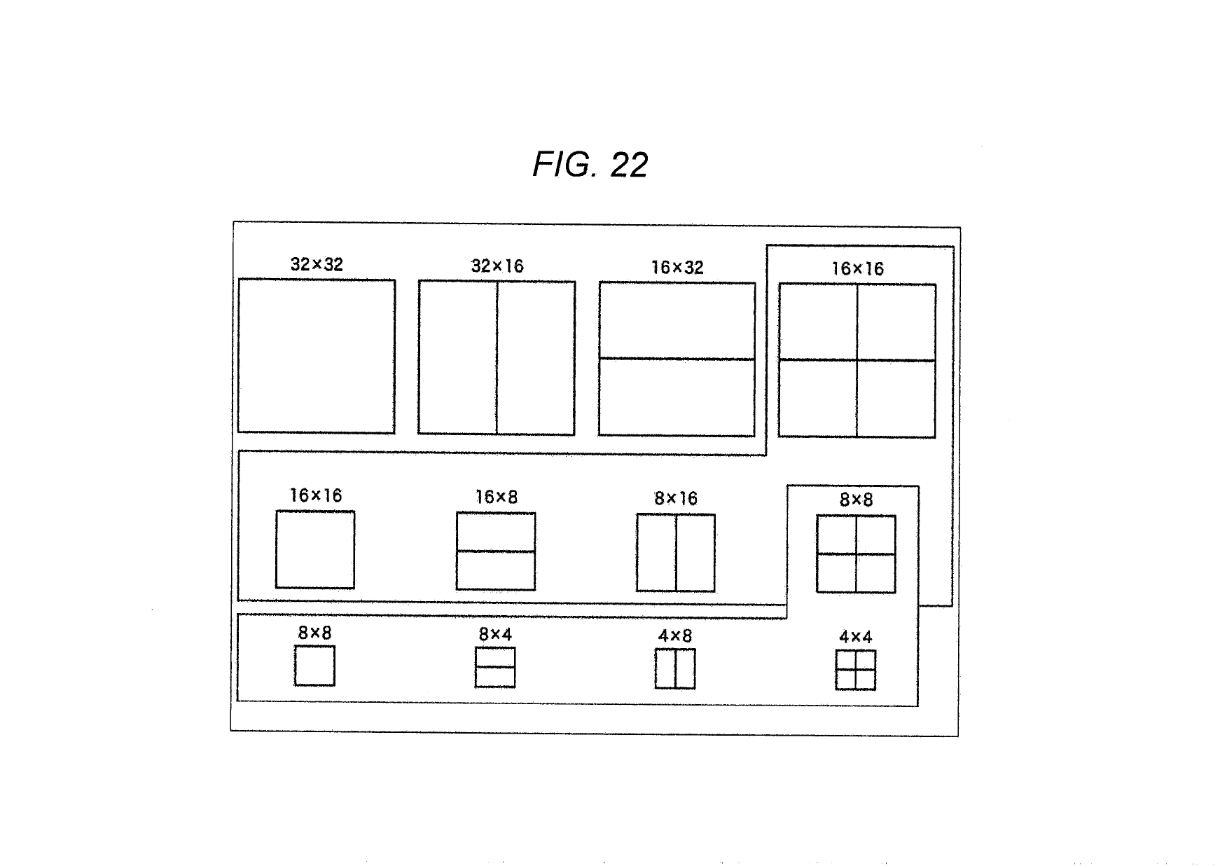

In H.264/AVC, the macroblock size is 16×16 pixels. However, the macroblock size of 16×16 pixels is not optimal for an UHD (Ultra High Definition: 4000×2000 pixels) frame to be encoded by a next-generation encoding method. In the image encoding device 500, the macroblock size can be 32×32 pixels, 64×64 pixels, or the like, as shown in FIG. 22.

FIG. 22 is a diagram showing examples of extended macroblock sizes. In the example shown in FIG. 32, the macroblock size is extended to 32×32 pixels.

In the top row in FIG. 22, macroblocks each formed with 32×32 pixels that are divided into a block (partition) of 32×32 pixels, blocks of 32×16 pixels, blocks of 16×32 pixels, and blocks of 16×16 pixels are shown in this order. In the middle row in FIG. 22, blocks each formed with 16×16 pixels that are divided into a block of 16×16 pixels, blocks of 16×8 pixels, blocks of 8×16 pixels, and blocks of 8×8 pixels are shown in this order. In the bottom row in FIG. 22, blocks each formed with 8×8 pixels that are divided into a block of 8×8 pixels, blocks of 8×4 pixels, blocks of 4×8 pixels, and blocks of 4×4 pixels are shown in this order.

That is, a macroblock of 32×32 pixels can be processed as the block of 32×32 pixels, the blocks of 32×16 pixels, the blocks of 16×32 pixels, or the blocks 16×16 pixels shown in the top row in FIG. 22.

Each of the blocks of 16×16 pixels shown at the right end of the top row can be processed as the block of 16×16 pixels, the blocks of 16×8 pixels, the blocks of 8×16 pixels, and the blocks of 8×8 pixels shown in the middle row, in the same manner as in H.264/AVC.

Each of the blocks of 8×8 pixels shown at the right end of the middle row can be processed as the block of 8×8 pixels, the blocks of 8×4 pixels, the blocks of 4×8 pixels, and the blocks of 4×4 pixels shown in the bottom row, in the same manner as in H.264/AVC.

Those blocks can be classified into the following three hierarchical levels. That is, the blocks of 32×32 pixels, 32×16 pixels, and 16×32 pixels shown in the top row in FIG. 22 are referred to as a first hierarchical level. The blocks of 16×16 pixels shown at the right end of the top row, and the blocks of 16×16 pixels, 16×8 pixels, and 8×16 pixels shown in the middle row are referred to as a second hierarchical level. The blocks of 8×8 pixels shown at the right end of the middle row, and the blocks of 8×8 pixels, 8×4 pixels, 4×8 pixels, and 4×4 pixels shown in the bottom row are referred to as a third hierarchical level.

The hierarchical structure shown in FIG. 22 is used, so that blocks of 16×16 pixels and smaller blocks maintain compatibility with the macroblocks of the current H.264/AVC. As the supersets of those blocks, even larger blocks are defined.

Any macroblock size may of course be used, and larger macroblocks than 64×64 pixels may be defined, for example.

### 3. Third Embodiment

### Personal Computer

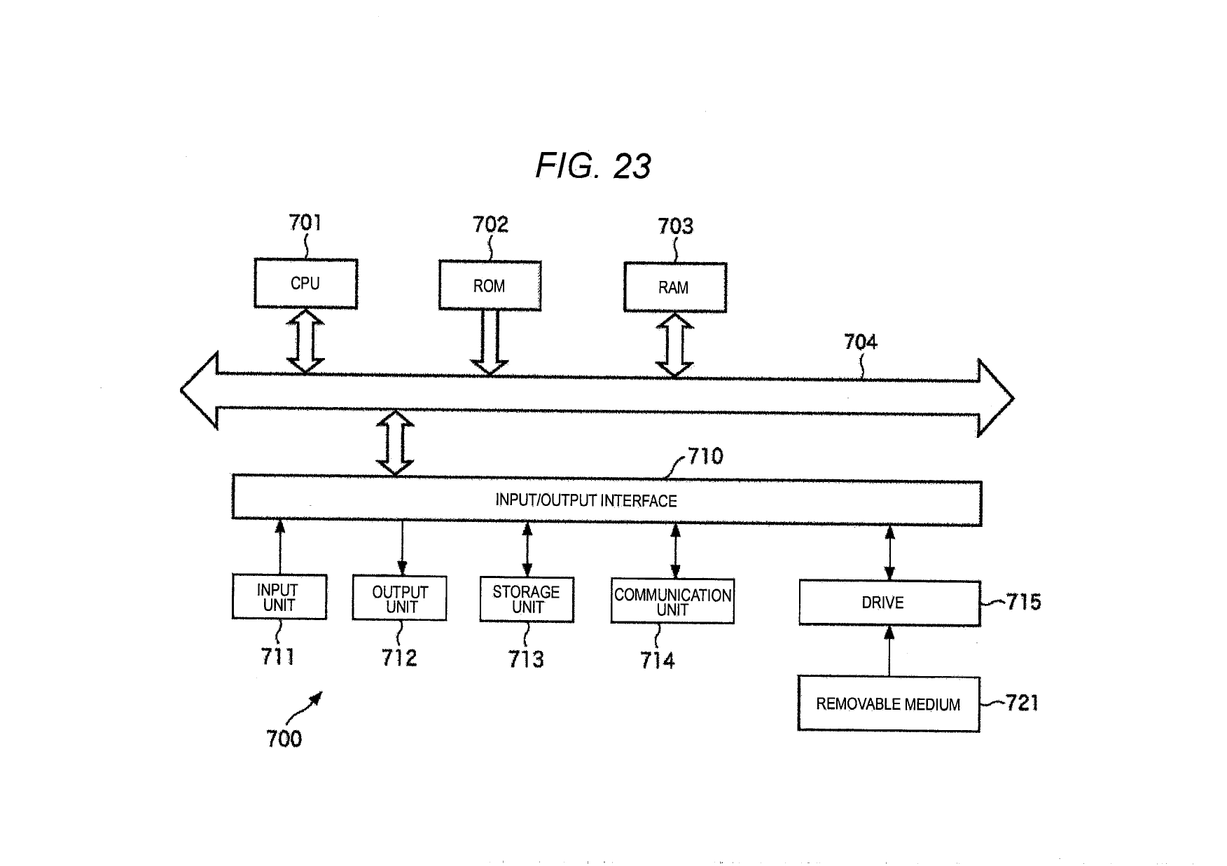

The above described series of operations can be performed by hardware or software. In this case, a personal computer shown in FIG. 23 may be formed, for example.

In FIG. 23, the CPU (Central Processing Unit) 701 of the personal computer 700 performs various kinds of operations in accordance with a program stored in a ROM (Read Only Memory) 702 or a program loaded into a RAM (Random Access Memory) 703 from a storage unit 713. The data necessary for the CPU 701 to perform various kinds of operations is also stored in the RAM 703 where necessary.

The CPU 701, the ROM 702, and the RAM 703 are connected to one another via a bus 704. An input/output interface 710 is also connected to the bus 704.

An input unit 711 formed with a keyboard, a mouse, and the like, an output unit 712 formed with a display such as a CRT (Cathode Ray Tube) or an LCD (Liquid Crystal Display) and a speaker or the like, the storage unit 713 formed with a hard disk or the like, and a communication unit 714 formed with a modem or the like are connected to the input/output interface 710. The communication unit 714 performs communicating operations via networks including the Internet.

A drive 715 is also connected to the input/output interface 710 where necessary, and a removable medium 721 such as a magnetic disk, an optical disk, a magneto-optical disk, a semiconductor memory, or the like is mounted on the drive 715 where appropriate. Computer programs read out from those media are installed in the storage unit 713 where necessary.

When the above described series of operations are performed by software, a program to form the software is installed from a network or a recording medium.

This recording medium may be distributed to deliver the program to users, separately from the device, as shown in FIG. 23. For example, this recording medium may be formed with the removable medium 721, such as a magnetic disk (or a flexible disk) having the program recorded thereon, an optical disk (or a CD-ROM (Compact Disc-Read Only Memory or a DVD (Digital Versatile Disc)), a magneto-optical disk (or a MD (Mini Disc)), or a semiconductor memory. Alternatively, this recording medium may be formed with the ROM 702 having the program recorded thereon, or a hard disk contained in the storage unit 713, or the like. The ROM 702 and the hard disk are incorporated into the device beforehand, and are distributed to users.

Each program to be executed by the computer may be a program for performing operations in chronological order in accordance with the sequences described in this specification, or may be a program for performing operations where necessary in parallel or when there is a call or the like.

In this specification, the step of writing a program to be recorded on a recording medium includes not only operations to be performed in chronological order in accordance with the disclosed sequences, but also operations to be performed in parallel or independently of one another if not in chronological order.

In this specification, a “system” means an entire apparatus formed with two or more devices (apparatuses).

In the above description, any structure described as one device (or one processing unit) may be divided and formed as two or more devices (or processing units). Conversely, any structure described as two or more devices (or processing units) may be formed as one device (or one processing unit). Also, a structure that has not been described above may of course be added to the structure of each device (or each processing unit). Further, as long as the structure and operations of the entire system will remain substantially the same, part of the structure of a device (or a processing unit) may be incorporated into the structure of another device (or another processing unit). That is, embodiments of this technique are not limited to the above described embodiments, and various modifications may be made to them without departing from the scope of the technique.

For example, the above described image encoding device and the above described image decoding device can be applied to any electronic apparatuses. In the following, examples of such applications are described.

### 4. Fourth Embodiment

### Television Receiver

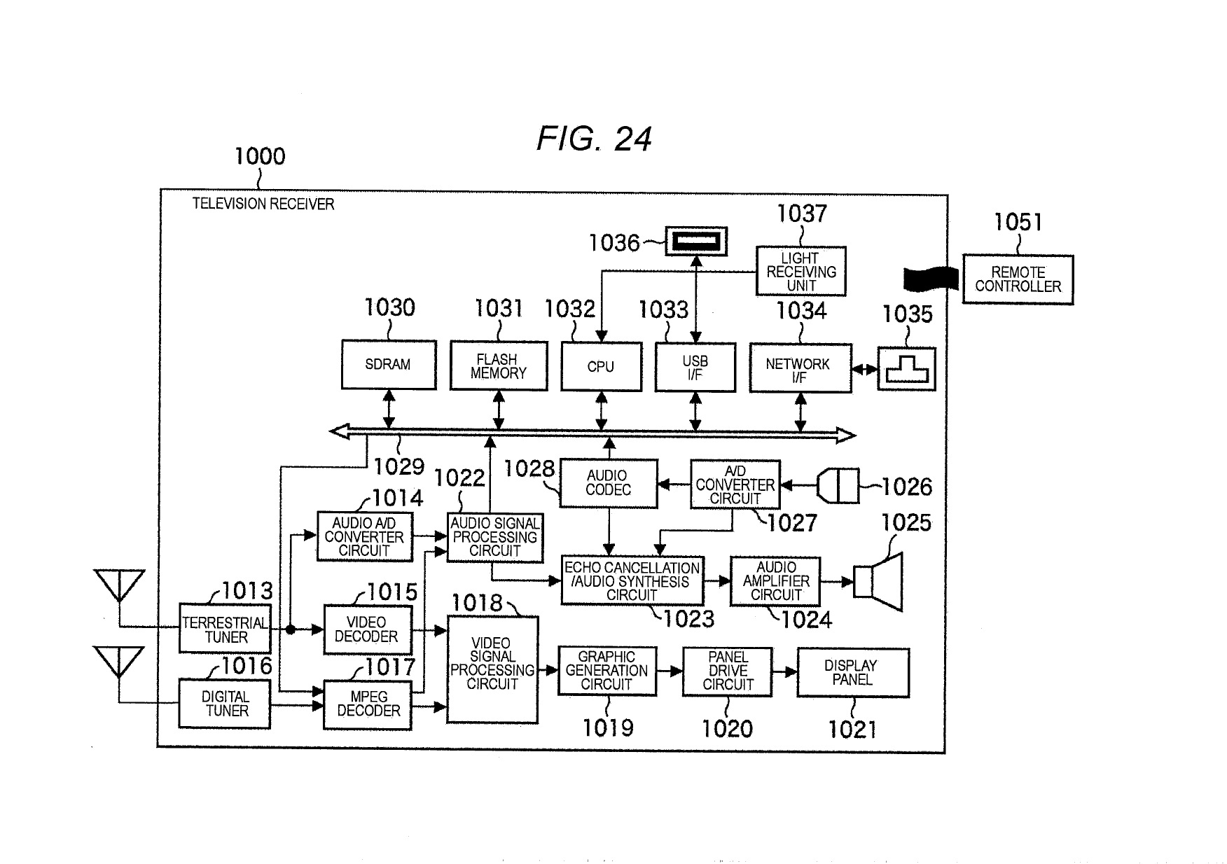

FIG. 24 is a block diagram showing a typical exemplary structure of a television receiver using the image decoding device 400.

The television receiver 1000 shown in FIG. 24 includes a terrestrial tuner 1013, a video decoder 1015, a video signal processing circuit 1018, a graphic generation circuit 1019, a panel drive circuit 1020, and a display panel 1021.

The terrestrial tuner 1013 receives a broadcast wave signal of analog terrestrial broadcasting via an antenna, demodulates the signal to obtain a video signal. The terrestrial tuner 1013 supplies the video signal to the video decoder 1015. The video decoder 1015 performs a decoding operation on the video signal supplied from the terrestrial tuner 1013, and supplies the resultant digital component signal to the video signal processing circuit 1018.

The video signal processing circuit 1018 performs predetermined processing such as denoising on the video data supplied from the video decoder 1015, and supplies the resultant video data to the graphic generation circuit 1019.

The graphic generation circuit 1019 generates video data of a show to be displayed on the display panel 1021, or image data by performing an operation based on an application supplied via a network. The graphic generation circuit 1019 supplies the generated video data or the image data to the panel drive circuit 1020. The graphic generation circuit 1019 also generates video data (a graphic) for displaying a screen to be used by a user to select an item, and superimposes the video data on the video data of the show. The resultant video data is supplied to the panel drive circuit 1020 where appropriate.

Based on the data supplied from the graphic generation circuit 1019, the panel drive circuit 1020 drives the display panel 1021, and causes the display panel 1021 to display the video image of the show and each screen described above.

The display panel 1021 is formed with an LCD (Liquid Crystal Display) or the like, and displays the video image of a show or the like under the control of the panel drive circuit 1020.

The television receiver 1000 also includes an audio A/D (Analog/Digital) converter circuit 1014, an audio signal processing circuit 1022, an echo cancellation/voice synthesis circuit 1023, an audio amplifier circuit 1024, and a speaker 1025.

The terrestrial tuner 1013 obtains not only a video signal but also an audio signal by demodulating a received broadcast wave signal. The terrestrial tuner 1013 supplies the obtained audio signal to the audio A/D converter circuit 1014.

The audio A/D converter circuit 1014 performs an A/D converting operation on the audio signal supplied from the terrestrial tuner 1013, and supplies the resultant digital audio signal to the audio signal processing circuit 1022.

The audio signal processing circuit 1022 performs predetermined processing such as denoising on the audio data supplied from the audio A/D converter circuit 1014, and supplies the resultant audio data to the echo cancellation/voice synthesis circuit 1023.

The echo cancellation/voice synthesis circuit 1023 supplies the audio data supplied from the audio signal processing circuit 1022 to the audio amplifier circuit 1024.

The audio amplifier circuit 1024 performs a D/A converting operation and an amplifying operation on the audio data supplied from the echo cancellation/voice synthesis circuit 1023. After adjusted to a predetermined sound volume, the sound is output from the speaker 1025.

The television receiver 1000 further includes a digital tuner 1016 and an MPEG decoder 1017.

The digital tuner 1016 receives a broadcast wave signal of digital broadcasting (digital terrestrial broadcasting or digital BS (Broadcasting Satellite)/CS (Communications Satellite) broadcasting) via the antenna, and demodulates the broadcast wave signal, to obtain an MPEG-TS (Moving Picture Experts Group-Transport Stream). The MPEG-TS is supplied to the MPEG decoder 1017.

The MPEG decoder 1017 descrambles the MPEG-TS supplied from the digital tuner 1016, and extracts the stream containing the data of the show to be reproduced (to be viewed). The MPEG decoder 1017 decodes the audio packet forming the extracted stream, and supplies the resultant audio data to the audio signal processing circuit 1022. The MPEG decoder 1017 also decodes the video packet forming the stream, and supplies the resultant video data to the video signal processing circuit 1018. The MPEG decoder 1017 also supplies EPG (Electronic Program Guide) data extracted from the MPEG-TS to a CPU 1032 via a path (not shown).

The television receiver 1000 uses the image decoding device 400 as the MPEG decoder 1017, which decodes the video packet as described above. The MPEG-TS transmitted from a broadcast station or the like has been encoded by the image encoding device 500.

Like the image decoding device 400, the MPEG decoder 1017 has the loop filter 401 to perform an adaptive loop filtering operation, where appropriate, on an image that has been subjected to a deblocking filtering operation by the deblocking filter 206, by using information supplied from a broadcast station (the image encoding device 500), such as an adaptive loop filter flag (adaptive_loop_filter_flag) and a filter coefficient. Accordingly, the MPEG decoder 1017 can perform an adaptive loop filtering operation more suited to the contents of images, and restrain image quality deterioration in decoded images.

The video data supplied from the MPEG decoder 1017 is subjected to predetermined processing at the video signal processing circuit 1018, as in the case of the video data supplied from the video decoder 1015. At the graphic generation circuit 1019, generated video data and the like are superimposed on the video data where appropriate. The resultant video data is supplied to the display panel 1021 via the panel drive circuit 1020, and the image is displayed.

The audio data supplied from the MPEG decoder 1017 is subjected to predetermined processing at the audio signal processing circuit 1022, as in the case of the audio data supplied from the audio A/D converter circuit 1014. The resultant audio data is supplied to the audio amplifier circuit 1024 via the echo cancellation/voice synthesis circuit 1023, and is subjected to a D/A converting operation or an amplifying operation. As a result, a sound that is adjusted to a predetermined sound level is output from the speaker 1025.

The television receiver 1000 also includes a microphone 1026 and an A/D converter circuit 1027.

The A/D converter circuit 1027 receives a signal of a user's voice captured by the microphone 1026 provided for voice conversations in the television receiver 1000. The A/D converter circuit 1027 performs an A/D converting operation on the received audio signal, and supplies the resultant digital audio data to the echo cancellation/voice synthesis circuit 1023.

When audio data of a user (a user A) of the television receiver 1000 is supplied from the A/D converter circuit 1027, the echo cancellation/voice synthesis circuit 1023 performs echo cancellation on the audio data of the user A, and combines the audio data with other audio data or the like. The resultant audio data is output from the speaker 1025 via the audio amplifier circuit 1024.

The television receiver 1000 further includes an audio codec 1028, an internal bus 1029, an SDRAM (Synchronous Dynamic Random Access Memory) 1030, a flash memory 1031, the CPU 1032, a USB (Universal Serial Bus) I/F 1033, and a network I/F 1034.

The A/D converter circuit 1027 receives the signal of the user's voice captured by the microphone 1026 provided for voice conversations in the television receiver 1000. The A/D converter circuit 1027 performs an A/D converting operation on the received audio signal, and supplies the resultant digital audio data to the audio codec 1028.

The audio 1028 transforms the audio data supplied from the A/D converter circuit 1027 into data in a predetermined format for transmission via a network, and supplies the result to the network I/F 1034 via the internal bus 1029.

The network I/F 1034 is connected to a network via a cable attached to a network terminal 1035. The network I/F 1034 transmits the audio data supplied from the audio codec 1028 to another device connected to the network, for example. The network I/F 1034 also receives, via the network terminal 1035, audio data transmitted from another device connected to the network, and supplies the audio data to the audio codec 1028 via the internal bus 1029.

The audio codec 1028 transforms the audio data supplied from the network I/F 1034 into data in a predetermined format, and supplies the result to the echo cancellation/voice synthesis circuit 1023.

The echo cancellation/voice synthesis circuit 1023 performs echo cancellation on the audio data supplied from the audio codec 1028, and combines the audio data with other audio data or the like. The resultant audio data is output from the speaker 1025 via the audio amplifier circuit 1024.

The SDRAM 1030 stores various kinds of data necessary for the CPU 1032 to perform processing.

The flash memory 1031 stores the program to be executed by the CPU 1032. The program stored in the flash memory 1031 is read by the CPU 1032 at a predetermined time, such as when the television receiver 1000 is activated. The flash memory 1031 also stores EPG data obtained through digital broadcasting, data obtained from a predetermined server via a network, and the like.

For example, the flash memory 1031 stores a MPEG-TS containing content data obtained from a predetermined server via a network, under the control of the CPU 1032. The flash memory 1031 supplies the MPEG-TS to the MPEG decoder 1017 via the internal bus 1029, under the control of the CPU 1032, for example.

The MPEG decoder 1017 processes the MPEG-TS, as in the case of the MPEG-TS supplied from the digital tuner 1016. In this manner, the television receiver 1000 receives the content data formed with a video image and a sound via the network, and decodes the content data by using the MPEG decoder 1017, to display the video image and output the sound.

The television receiver 1000 also includes a light receiving unit 1037 that receives an infrared signal transmitted from a remote controller 1051.

The light receiving unit 1037 receives an infrared ray from the remote controller 1051, and outputs a control code indicating the contents of a user operation obtained through decoding, to the CPU 1032.

The CPU 1032 executes the program stored in the flash memory 1031, and controls the entire operation of the television receiver 1000 in accordance with the control code and the like supplied from the light receiving unit 1037. The respective components of the television receiver 1000 are connected to the CPU 1032 via paths (not shown).

The USB I/F 1033 exchanges data with an apparatus that is located outside the television receiver 1000 and is connected to thereto via a USB cable attached to a USB terminal 1036. The network I/F 1034 is connected to the network via the cable attached to the network terminal 1035, and also exchanges data other than audio data with any kinds of devices connected to the network.

Using the image decoding device 400 as the MPEG decoder 1017, the television receiver 1000 can perform an adaptive loop filtering operation more suited to the contents of images on broadcast wave signals received via an antenna or content data obtained via a network, and can restrain deterioration of the subjective image quality of decoded images.

### 5. Fifth Embodiment

### Portable Telephone Device

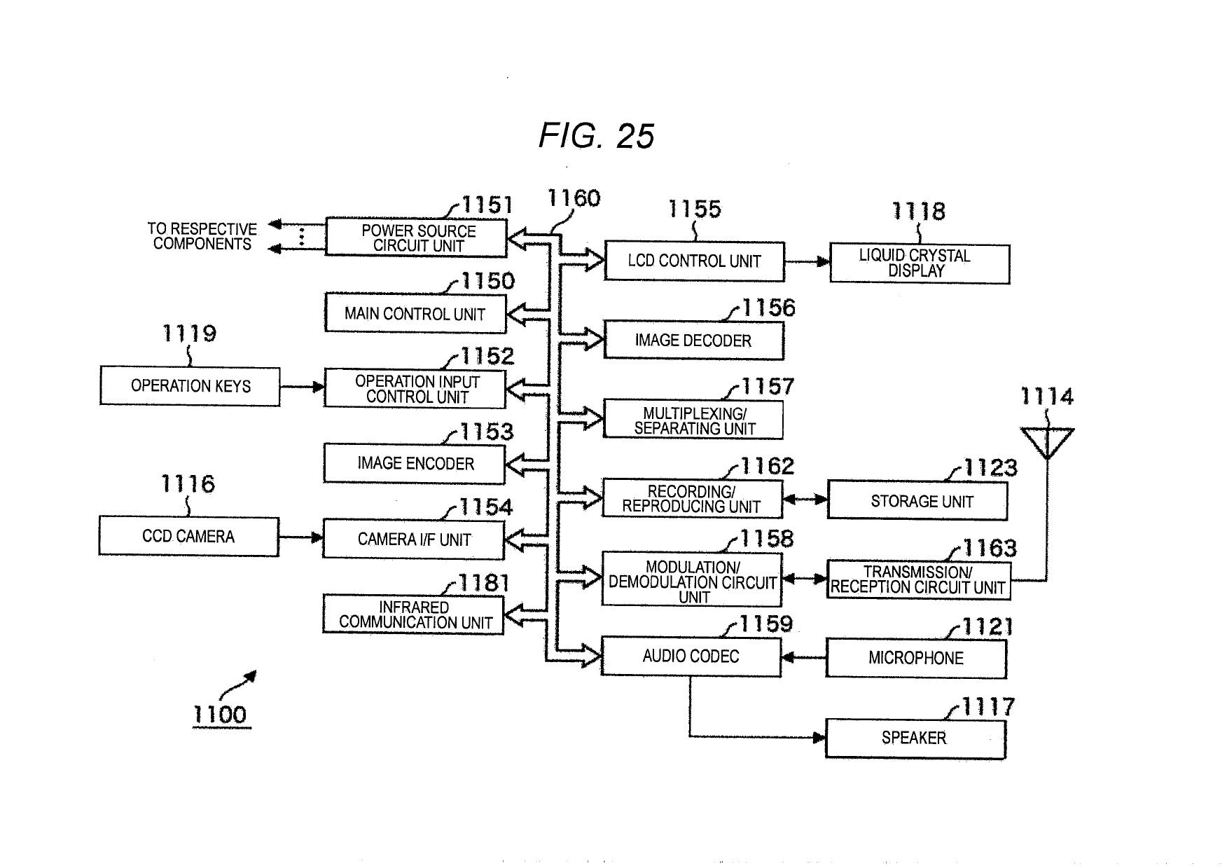

FIG. 25 is a block diagram showing a typical exemplary structure of a portable telephone device using the image encoding device 500 and the image decoding device 400.

The portable telephone device 1100 shown in FIG. 25 includes a main control unit 1150 designed to collectively control respective components, a power source circuit unit 1151, an operation input control unit 1152, an image encoder 1153, a camera I/F unit 1154, an LCD control unit 1155, an image decoder 1156, a multiplexing/separating unit 1157, a recording/reproducing unit 1162, a modulation/demodulation circuit unit 1158, and an audio codec 1159. Those components are connected to one another via a bus 1160.

The portable telephone device 1100 also includes operation keys 1119, a CCD (Charge Coupled Device) camera 1116, a liquid crystal display 1118, a storage unit 1123, a transmission/reception circuit unit 1163, an antenna 1114, a microphone (mike) 1121, and a speaker 1117.

When a call is ended or the power key is switched on by a user's operation, the power source circuit unit 1151 puts the portable telephone device 1100 into an operable state by supplying power from a battery pack to the respective components.

Under the control of the main control unit 1150 formed with a CPU, a ROM, a RAM, and the like, the portable telephone device 1100 performs various kinds of operations, such as transmission and reception of audio signals, transmission and reception of electronic mail and image data, image capturing, and data recording, in various kinds of modes such as a voice communication mode and a data communication mode.

In the portable telephone device 1100 in the voice communication mode, for example, an audio signal captured by the microphone (mike) 1121 is transformed into digital audio data by the audio codec 1159, and the digital audio data is subjected to spread spectrum processing at the modulation/demodulation circuit unit 1158. The resultant data is then subjected to a digital-analog converting operation and a frequency converting operation at the transmission/reception circuit unit 1163. The portable telephone device 1100 transmits the transmission signal obtained through the converting operations to a base station (not shown) via the antenna 1114. The transmission signal (audio signal) transmitted to the base station is further supplied to the portable telephone device at the other end of the communication via a public telephone line network.

In the portable telephone device 1100 in the voice communication mode, for example, a reception signal received by the antenna 1114 is amplified at the transmission/reception circuit unit 1163, and is further subjected to a frequency converting operation and an analog-digital converting operation. The resultant signal is subjected to inverse spread spectrum processing at the modulation/demodulation circuit unit 1158, and is transformed into an analog audio signal by the audio codec 1159. The portable telephone device 1100 outputs, from the speaker 1117, the analog audio signal obtained through the conversions.

Further, when electronic mail is transmitted in the data communication mode, for example, the operation input control unit 1152 of the portable telephone device 1100 receives text data of the electronic mail that is input by operating the operation keys 1119. The portable telephone device 1100 processes the text data at the main control unit 1150, and displays the text data as an image on the liquid crystal display 1118 via the LCD control unit 1155.

In the portable telephone device 1100, the main control unit 1150 generates electronic mail data, based on text data, a user's instruction, or the like received by the operation input control unit 1152. The portable telephone device 1100 subjects the electronic mail data to spread spectrum processing at the modulation/demodulation circuit unit 1158, and to a digital-analog converting operation and a frequency converting operation at the transmission/reception circuit unit 1163. The portable telephone device 1100 transmits the transmission signal obtained through the converting operations to a base station (not shown) via the antenna 1114. The transmission signal (electronic mail) transmitted to the base station is supplied to a predetermined address via a network, a mail server, and the like.

When electronic mail is received in the data communication mode, for example, the transmission/reception circuit unit 1163 of the portable telephone device 1100 receives a signal transmitted from a base station via the antenna 1114, and the signal is amplified and is further subjected to a frequency converting operation and an analog-digital converting operation. The portable telephone device 1100 subjects the received signal to inverse spread spectrum processing at the modulation/demodulation circuit unit 1158, to uncompress the original electronic mail data. The portable telephone device 1100 displays the uncompressed electronic mail data on the liquid crystal display 1118 via the LCD control unit 1155.

The portable telephone device 1100 can also record (store) the received electronic mail data into the storage unit 1123 via the recording/reproducing unit 1162.

The storage unit 1123 is a rewritable storage medium. The storage unit 1123 may be a semiconductor memory such as a RAM or an internal flash memory, a hard disk, or a removable medium such as a magnetic disk, a magneto-optical disk, an optical disk, a USB memory, or a memory card. It is of course possible to use a memory other than the above.

Further, when image data is transmitted in the data communication mode, for example, the portable telephone device 1100 generates the image data at the CCD camera 1116 capturing an image. The CCD camera 1116 includes optical devices such as a lens and a diaphragm, and a CCD as a photoelectric conversion device. The CCD camera 1116 captures an image of an object, converts the intensity of received light into an electrical signal, and generates image data of the image of the object. The CCD camera 1116 encodes the image data at the image encoder 1153 via the camera I/F unit 1154, to obtain encoded image data.

The portable telephone device 1100 uses the above described image encoding device 500 as the image encoder 1153 that performs the above operation. In the same manner as in the case of the image encoding device 500, the image encoder 1153 has the filter control unit 501 to control the operation of the adaptive loop filter 502 in accordance with types of images. By doing so, the image encoder 1153 can perform an adaptive loop filtering operation more suited to images, and can reduce the encoding operation load while restraining image quality deterioration in decoded images.

At the same time as above, in the portable telephone device 1100, the sound captured by the microphone (mike) 1121 during the image capturing by the CCD camera 1116 is analog-digital converted at the audio codec 1159, and is further encoded.

The multiplexing/separating unit 1157 of the portable telephone device 1100 multiplexes the encoded image data supplied from the image encoder 1153 and the digital audio data supplied from the audio codec 1159 by a predetermined technique. The portable telephone device 1100 subjects the resultant multiplexed data to spread spectrum processing at the modulation/demodulation circuit unit 1158, and to a digital-analog converting operation and a frequency converting operation at the transmission/reception circuit unit 1163. The portable telephone device 1100 transmits the transmission signal obtained through the converting operations to a base station (not shown) via the antenna 1114. The transmission signal (image data) transmitted to the base station is supplied to the other end of the communication via a network or the like.

When image data is not transmitted, the portable telephone device 1100 can also display image data generated at the CCD camera 1116 on the liquid crystal display 1118 via the LCD control unit 1155, instead of the image encoder 1153.

When the data of a moving image file linked to a simplified homepage or the like is received in the data communication mode, the transmission/reception circuit unit 1163 of the portable telephone device 1100 receives a signal transmitted from a base station via the antenna 1114. The signal is amplified, and is further subjected to a frequency converting operation and an analog-digital converting operation. The portable telephone device 1100 subjects the received signal to inverse spread spectrum processing at the modulation/demodulation circuit unit 1158, to uncompress the original multiplexed data. The portable telephone device 1100 divides the multiplexed data into encoded image data and audio data at the multiplexing/separating unit 1157.

By decoding the encoded image data at the image decoder 1156, the portable telephone device 1100 generates reproduced moving image data, and displays the reproduced moving image data on the liquid crystal display 1118 via the LCD control unit 1155. In this manner, the moving image data contained in a moving image file linked to a simplified homepage, for example, is displayed on the liquid crystal display 1118.

The portable telephone device 1100 uses the above described image decoding device 400 as the image decoder 1156 that performs the above operation. Like the image decoding device 400, the image decoder 1156 performs an adaptive loop filtering operation, where appropriate, on an image that has been subjected to a deblocking filtering operation by the deblocking filter 206, by using information supplied from the encoding side (the image encoding device 500), such as an adaptive loop filter flag (adaptive_loop_filter_flag) and a filter coefficient. Accordingly, the image decoder 1156 can perform an inverse quantization operation more suited to the contents of images, and restrain image quality deterioration in decoded images.

At the same time as above, the portable telephone device 1100 transforms the digital audio data into an analog audio signal at the audio codec 1159, and outputs the analog audio signal from the speaker 1117. In this manner, the audio data contained in a moving image file linked to a simplified homepage, for example, is reproduced.

As in the case of electronic mail, the portable telephone device 1100 can also record (store) received data linked to a simplified homepage or the like into the storage unit 1123 via the recording/reproducing unit 1162.

The main control unit 1150 of the portable telephone device 1100 can also analyze a two-dimensional code obtained by the CCD camera 1116 performing image capturing, to obtain the information recorded in the two-dimensional code.

Further, an infrared communication unit 1181 of the portable telephone device 1100 can communicate with an external apparatus by using infrared rays.

By using the image encoding device 500 as the image encoder 1153, the portable telephone device 1100 can perform an adaptive loop filtering operation more suited to images, and generate encoded image data so as to reduce the encoding operation load while restraining deterioration of the subjective image quality of decoded images, when image data generated at the CCD camera 1116 is encoded and transmitted, for example.

Also, by using the image decoding device 400 as the image decoder 1156, the portable telephone device 1100 can perform an adaptive loop filtering operation more suited to images, and restrain deterioration of the subjective image quality of decoded images, when the data (encoded data) of a moving image file linked to a simplified homepage is decoded, for example.

In the above description, the portable telephone device 1100 uses the CCD camera 1116. However, instead of the CCD camera 1116, an image sensor (a CMOS image sensor) using a CMOS (Complementary Metal Oxide Semiconductor) may be used. In that case, the portable telephone device 1100 can also capture an image of an object, and generate the image data of the image of the object, as in the case where the CCD camera 1116 is used.

Although the portable telephone device 1100 has been described above, the image encoding device 500 and the image decoding device 400 can also be applied to any device in the same manner as in the case of the portable telephone device 1100, as long as the device has the same image capturing function and the same communication function as the portable telephone device 1100. Such a device may be a PDA (Personal Digital Assistant), a smartphone, an UMPC (Ultra Mobile Personal Computer), a netbook, or a notebook personal computer, for example.

### 6. Sixth Embodiment

### Hard Disk Recorder

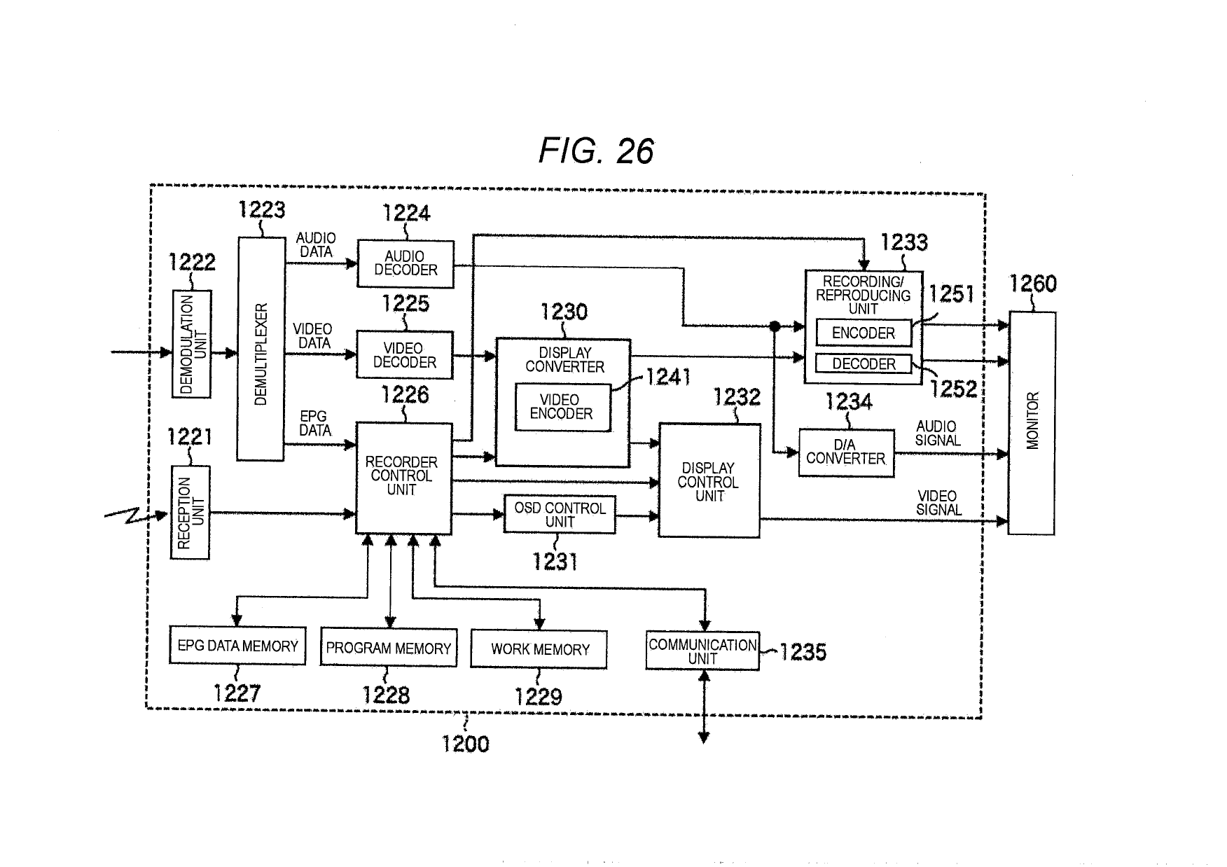

FIG. 26 is a block diagram showing a typical exemplary structure of a hard disk recorder using the image encoding device 500 and the image decoding device 400.

The hard disk recorder (a HDD recorder) 1200 shown in FIG. 26 is a device that stores, into an internal hard disk, the audio data and the video data of a broadcast show contained in a broadcast wave signal (a television signal) that is transmitted from a satellite or a terrestrial antenna or the like and is received by a tuner, and provides the stored data to a user at a time designated by an instruction from the user.

The hard disk recorder 1200 can extract audio data and video data from a broadcast wave signal, for example, decode those data where appropriate, and store the data into an internal hard disk. Also, the hard disk recorder 1200 can obtain audio data and video data from another device via a network, for example, decode those data where appropriate, and store the data into an internal hard disk.

Further, the hard disk recorder 1200 can decode audio data and video data recorded on an internal hard disk, for example, supply those data to a monitor 1260, display the image on the screen of the monitor 1260, and output the sound from the speaker of the monitor 1260. Also, the hard disk recorder 1200 can decode audio data and video data extracted from a broadcast wave signal obtained via a tuner, or audio data and video data obtained from another device via a network, for example, supply those data to the monitor 1260, display the image on the screen of the monitor 1260, and output the sound from the speaker of the monitor 1260.

The hard disk recorder 1200 can of course perform operations other than the above.

As shown in FIG. 26, the hard disk recorder 1200 includes a reception unit 1221, a demodulation unit 1222, a demultiplexer 1223, an audio decoder 1224, a video decoder 1225, and a recorder control unit 1226. The hard disk recorder 1200 further includes an EPG data memory 1227, a program memory 1228, a work memory 1229, a display converter 1230, an OSD (On-Screen Display) control unit 1231, a display control unit 1232, a recording/reproducing unit 1233, a D/A converter 1234, and a communication unit 1235.

The display converter 1230 includes a video encoder 1241. The recording/reproducing unit 1233 includes an encoder 1251 and a decoder 1252.

The reception unit 1221 receives an infrared signal from a remote controller (not shown), converts the infrared signal into an electrical signal, and outputs the electrical signal to the recorder control unit 1226. The recorder control unit 1226 is formed with a microprocessor, for example, and performs various kinds of operations in accordance with a program stored in the program memory 1228. At this point, the recorder control unit 1226 uses the work memory 1229 where necessary.

The communication unit 1235 is connected to a network, and performs a communication operation with another device via the network. For example, under the control of the recorder control unit 1226, the communication unit 1235 communicates with a tuner (not shown), and outputs a station select control signal mainly to the tuner.

The demodulation unit 1222 demodulates a signal supplied from the tuner, and outputs the signal to the demultiplexer 1223. The demultiplexer 1223 divides the data supplied from the demodulation unit 1222 into audio data, video data, and EPG data. The demultiplexer 1223 outputs the audio data, the video data, and the EPG data to the audio decoder 1224, the video decoder 1225, and the recorder control unit 1226, respectively.

The audio decoder 1224 decodes the input audio data, and outputs the decoded audio data to the recording/reproducing unit 1233. The video decoder 1225 decodes the input video data, and outputs the decoded video data to the display converter 1230. The recorder control unit 1226 supplies and stores the input EPG data into the EPG data memory 1227.

The display converter 1230 encodes video data supplied from the video decoder 1225 or the recorder control unit 1226 into video data compliant with the NTSC (National Television Standards Committee) standards, for example, using the video encoder 1241. The encoded video data is output to the recording/reproducing unit 1233. Also, the display converter 1230 converts the screen size of video data supplied from the video decoder 1225 or the recorder control unit 1226 into a size compatible with the size of the monitor 1260. The video encoder 1241 converts the video data into video data compliant with the NTSC standards. The NTSC video data is converted into an analog signal, and is output to the display control unit 1232.

Under the control of the recorder control unit 1226, the display control unit 1232 superimposes an OSD signal output from the OSD (On-Screen Display) control unit 1231 on the video signal input from the display converter 1230, and outputs the resultant signal to the display of the monitor 1260 to display the image.

Audio data that is output from the audio decoder 1224 and is converted into an analog signal by the D/A converter 1234 is also supplied to the monitor 1260. The monitor 1260 outputs the audio signal from an internal speaker.

The recording/reproducing unit 1233 includes a hard disk as a storage medium for recording video data, audio data, and the like.

The recording/reproducing unit 1233 causes the encoder 1251 to encode audio data supplied from the audio decoder 1224, for example. The recording/reproducing unit 1233 also causes the encoder 1251 to encode video data supplied from the video encoder 1241 of the display converter 1230. The recording/reproducing unit 1233 combines the encoded data of the audio data with the encoded data of the video data, using a multiplexer. The recording/reproducing unit 1233 amplifies the combined data through channel coding, and writes the resultant data on the hard disk via a recording head.

The recording/reproducing unit 1233 reproduces data recorded on the hard disk via a reproduction head, amplifies the data, and divides the data into audio data and video data by using a demultiplexer. The recording/reproducing unit 1233 decodes the audio data and the video data by using the decoder 1252. The recording/reproducing unit 1233 performs a D/A conversion on the decoded audio data, and outputs the result to the speaker of the monitor 1260. The recording/reproducing unit 1233 also performs a D/A conversion on the decoded video data, and outputs the result to the display of the monitor 1260.

Based on a user's instruction indicated by an infrared signal that is transmitted from a remote controller and is received via the reception unit 1221, the recorder control unit 1226 reads the latest EPG data from the EPG data memory 1227, and supplies the EPG data to the OSD control unit 1231. The OSD control unit 1231 generates image data corresponding to the input EPG data, and outputs the image data to the display control unit 1232. The display control unit 1232 outputs the video data input from the OSD control unit 1231 to the display of the monitor 1260, to display the image. In this manner, an EPG (Electronic Program Guide) is displayed on the display of the monitor 1260.

The hard disk recorder 1200 can also obtain various kinds of data, such as video data, audio data, and EPG data, which are supplied from another device via a network such as the Internet.

Under the control of the recorder control unit 1226, the communication unit 1235 obtains encoded data of video data, audio data, EPG data, and the like from another device via a network, and supplies those data to the recorder control unit 1226. For example, the recorder control unit 1226 supplies encoded data of obtained video data and audio data to the recording/reproducing unit 1233, and stores those data into the hard disk. At this point, the recorder control unit 1226 and the recording/reproducing unit 1233 may perform an operation such as a re-encoding where necessary.

The recorder control unit 1226 also decodes encoded data of obtained video data and audio data, and supplies the resultant video data to the display converter 1230. The display converter 1230 processes the video data supplied from the recorder control unit 1226 in the same manner as processing video data supplied from the video decoder 1225, and supplies the result to the monitor 1260 via the display control unit 1232, to display the image.

In synchronization with the image display, the recorder control unit 1226 may supply the decoded audio data to the monitor 1260 via the D/A converter 1234, and output the sound from the speaker.

Further, the recorder control unit 1226 decodes encoded data of obtained EPG data, and supplies the decoded EPG data to the EPG data memory 1227.

The above described hard disk recorder 1200 uses the image decoding device 400 as the video decoder 1225, the decoder 1252, and the decoder installed in the recorder control unit 1226. That is, like the image decoding device 400, the video decoder 1225, the decoder 1252, and the decoder installed in the recorder control unit 1226 perform an adaptive loop filtering operation, where appropriate, on an image that has been subjected to a deblocking filtering operation by the deblocking filter 206, by using information supplied from the encoding side (the image encoding device 500), such as an adaptive loop filter flag (adaptive_loop_filter_flag) and a filter coefficient. Accordingly, the video decoder 1225, the decoder 1252, and the decoder installed in the recorder control unit 1226 can perform an adaptive loop filtering operation more suited to images, and restrain image quality deterioration in decoded images.

Thus, the hard disk recorder 1200 can perform an adaptive loop filtering operation more suited to image, on video data (encoded data) received by a tuner or the communication unit 1235 and video data (encoded data) to be reproduced by the recording/reproducing unit 1233, and restrain deterioration of the subjective image quality of decoded images.

The hard disk recorder 1200 also uses the image encoding device 500 as the encoder 1251. Accordingly, in the same manner as in the case of the image encoding device 500, the encoder 1251 has the filter control unit 501 to control the operation of the adaptive loop filter 502 in accordance with types of images. By doing so, the encoder 1251 can perform an adaptive loop filtering operation more suited to images, and can reduce the encoding operation load while restraining image quality deterioration in decoded images.

Accordingly, when encoded data to be recorded on a hard disk is generated, the hard disk recorder 1200 can perform an adaptive loop filtering operation more suited to images, and generate encoded data so as to reduce the encoding operation load while restraining deterioration of the subjective image quality of decoded images.

In the above description, the hard disk recorder 1200 that records video data and audio data on a hard disk has been described. However, any other recording medium may be used. For example, as in the case of the above described hard disk recorder 1200, the image encoding device 500 and the image decoding device 400 can be applied to a recorder that uses a recording medium other than a hard disk, such as a flash memory, an optical disk, or a videotape.

### 7. Seventh Embodiment

### Camera

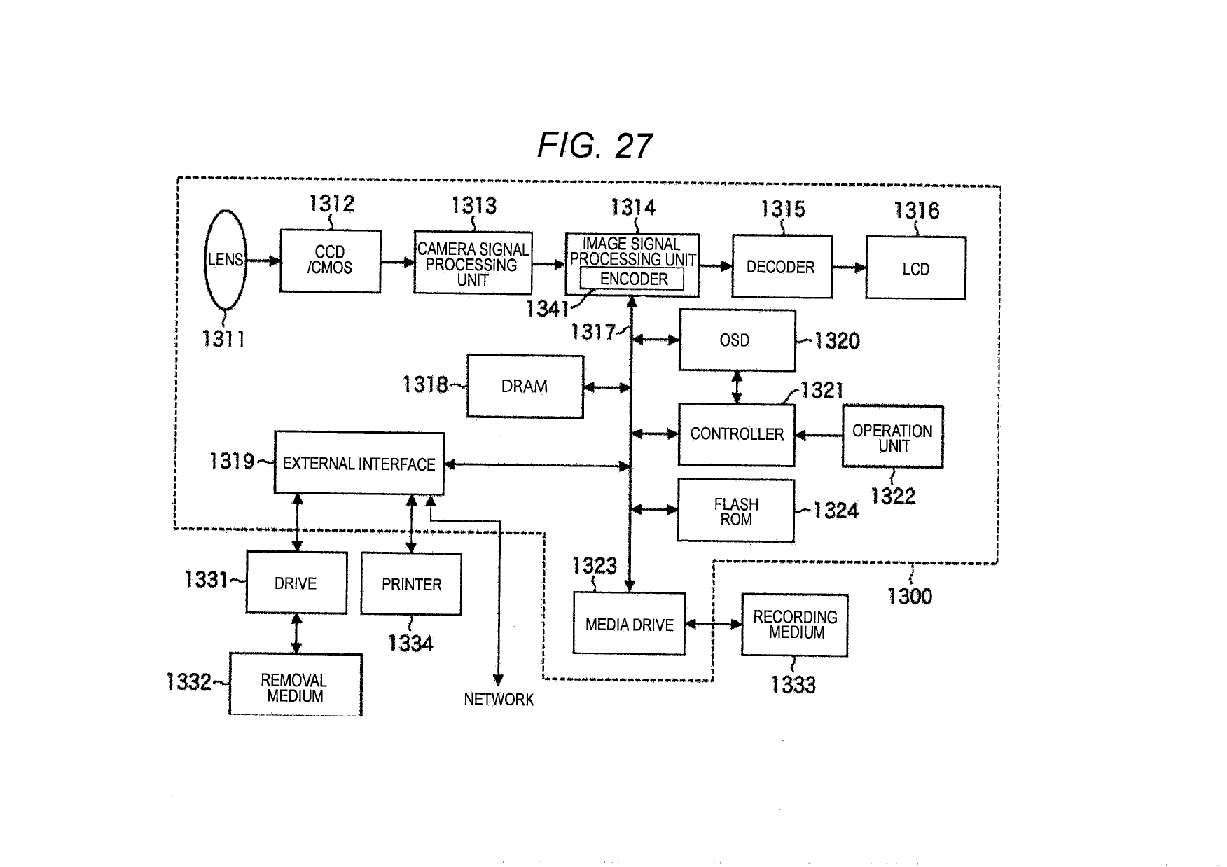

FIG. 27 is a block diagram showing a typical exemplary structure of a camera using the image encoding device 500 and the image decoding device 400.

The camera 1300 shown in FIG. 27 captures an image of an object, and displays the image of the object on an LCD 1316 or records the image of the object as image data on a recording medium 1333.

A lens block 1311 has light (or a video image of an object) incident on a CCD/CMOS 1312. The CCD/CMOS 1312 is an image sensor using a CCD or a CMOS. The CCD/CMOS 1312 converts the intensity of the received light into an electrical signal, and supplies the electrical signal to a camera signal processing unit 1313.

The camera signal processing unit 1313 transforms the electrical signal supplied from the CCD/CMOS 1312 into a YCrCb chrominance signal, and supplies the signal to an image signal processing unit 1314. Under the control of a controller 1321, the image signal processing unit 1314 performs predetermined image processing on the image signal supplied from the camera signal processing unit 1313, and encodes the image signal by using an encoder 1341. The image signal processing unit 1314 supplies the encoded data generated by encoding the image signal to a decoder 1315. The image signal processing unit 1314 further obtains display data generated at an on-screen display (OSD) 1320, and supplies the display data to the decoder 1315.

In the above operation, the camera signal processing unit 1313 uses a DRAM (Dynamic Random Access Memory) 1318 connected thereto via a bus 1317, to store the image data and the encoded data or the like generated by encoding the image data into the DRAM 1318 where necessary.

The decoder 1315 decodes the encoded data supplied from the image signal processing unit 1314, and supplies the resultant image data (decoded image data) to the LCD 1316. The decoder 1315 also supplies the display data supplied from the image signal processing unit 1314 to the LCD 1316. The LCD 1316 combines the image corresponding to the decoded image data supplied from the decoder 1315 with the image corresponding to the display data, and displays the combined image.

Under the control of the controller 1321, the on-screen display 1320 outputs the display data of a menu screen or icons formed with symbols, characters, or figures, to the image signal processing unit 1314 via the bus 1317.

Based on a signal indicating contents designated by a user using an operation unit 1322, the controller 1321 performs various kinds of operations, and controls, via the bus 1317, the image signal processing unit 1314, the DRAM 1318, an external interface 1319, the on-screen display 1320, a media drive 1323, and the like. A flash ROM 1324 stores programs, data, and the like necessary for the controller 1321 to perform various kinds of operations.

For example, in place of the image signal processing unit 1314 and the decoder 1315, the controller 1321 can encode the image data stored in the DRAM 1318, and decode the encoded data stored in the DRAM 1318. In doing so, the controller 1321 may perform encoding and decoding operations by using the same methods as the encoding and decoding methods used by the image signal processing unit 1314 and the decoder 1315, or may perform encoding and decoding operations by using methods that are not compatible with the image signal processing unit 1314 and the decoder 1315.

When a start of image printing is requested through the operation unit 1322, for example, the controller 1321 reads image data from the DRAM 1318, and supplies the image data to a printer 1334 connected to the external interface 1319 via the bus 1317, so that the printing is performed.

Further, when image recording is requested through the operation unit 1322, for example, the controller 1321 reads encoded data from the DRAM 1318, and supplies and stores the encoded data into the recording medium 1333 mounted on the media drive 1323 via the bus 1317.

The recording medium 1333 is a readable and writable removable medium, such as a magnetic disk, a magneto-optical disk, an optical disk, or a semiconductor memory. The recording medium 1333 may be any kind of removable medium, and may be a tape device, a disk, or a memory card. It is of course possible to use a non-contact IC card or the like.

Alternatively, the media drive 1323 and the recording medium 1333 may be integrated, and may be formed with an immobile storage medium such as an internal hard disk drive or an SSD (Solid State Drive).

The external interface 1319 is formed with a USB input/output terminal and the like, for example, and is connected to the printer 1334 when image printing is performed. Also, a drive 1331 is connected to the external interface 1319 where necessary, and a removable medium 1332 such as a magnetic disk, an optical disk, or a magneto-optical disk is mounted on the drive 1331 where appropriate. A computer program that is read from such a disk is installed in the flash ROM 1324 where necessary.

Further, the external interface 1319 includes a network interface connected to a predetermined network such as a LAN or the Internet. In accordance with an instruction from the operation unit 1322, for example, the controller 1321 can read encoded data from the DRAM 1318, and supply the encoded data from the external interface 1319 to another device connected thereto via a network. Also, the controller 1321 can obtain encoded data and image data supplied from another device via a network, and store the data into the DRAM 1318 or supply the data to the image signal processing unit 1314 via the external interface 1319.

The above camera 1300 uses the image decoding device 400 as the decoder 1315. That is, like the image decoding device 400, the decoder 1315 performs an adaptive loop filtering operation, where appropriate, on an image that has been subjected to a deblocking filtering operation by the deblocking filter 206, by using information supplied from the encoding side (the image encoding device 500), such as an adaptive loop filter flag (adaptive_loop_filter_flag) and a filter coefficient. Accordingly, the decoder 1315 can perform an adaptive loop filtering operation more suited to images, and restrain image quality deterioration in decoded images.

Accordingly, the camera 1300 can perform an adaptive loop filtering operation more suited to images on image data generated at the CCD/CMOS 1312, encoded data of video data read from the DRAM 1318 or the recording medium 1333, or encoded data of video data obtained via a network, for example, and restrain deterioration of subjective image quality.

Also, the camera 1300 uses the image encoding device 500 as the encoder 1341. In the same manner as in the case of the image encoding device 500, the encoder 1341 has the filter control unit 501 to control the operation of the adaptive loop filter 502 in accordance with types of images. By doing so, the encoder 1341 can perform an adaptive loop filtering operation more suited to images, and can reduce the encoding operation load while restraining image quality deterioration in decoded images.

Accordingly, when encoded data to be recorded on the DRAM 1318 or the recording medium 1333 is generated, or encoded data to be provided to another device is generated, the camera 1300 can perform an adaptive loop filtering operation more suited to images, and reduce the encoding operation load while restraining deterioration of the subjective image quality of decoded images.

The decoding method used by the image decoding device 400 may be applied to decoding operations to be performed by the controller 1321. Likewise, the encoding method used by the image encoding device 500 may be applied to encoding operations to be performed by the controller 1321.

Image data to be captured by the camera 1300 may be of a moving image, or may be of a still image.

It is of course possible to apply the image encoding device 500 and the image decoding device 400 to any devices and systems other than the above described devices.

This technique can also be in the following forms.

(1) An image processing device that includes:

a filter control unit that controls an adaptive filtering operation to be performed on image data, in accordance with whether the image data is to be referred to by other image data; and

a filtering operation unit that performs the adaptive filtering operation on the image data under the control of the filter control unit in a motion compensation loop.

(2) The image processing device of (1), wherein,

when the image data being subjected to the adaptive filtering operation is to be referred to by the other image data in an operation to encode the image data, the filter control unit controls the adaptive filtering operation to be performed, and

when the image data being subjected to the adaptive filtering operation is not to be referred to by the other image data in the operation to encode the image data, the filter control unit controls the adaptive filtering operation not to be performed.

(3) The image processing device of (1) or (2), wherein

the image data is picture data, and

the filter control unit controls the adaptive filtering operation for the image data in accordance with a type of the picture.

(4) The image processing device of (3), wherein the filter control unit controls the adaptive filtering operation to be performed when the image data is an I-picture, and controls the adaptive filtering operation not to be performed when the image data is a P-picture and a B-picture.

(5) The image processing device of (3), wherein the filter control unit controls the adaptive filtering operation to be performed when the image data is an I-picture or a P-picture, and controls the adaptive filtering operation not to be performed when the image data is a B-picture.

(6) The image processing device of (3), wherein the filter control unit controls the adaptive filtering operation to be performed when the image data is an I-picture and a P-picture in image data containing hierarchical B-pictures, or a B-picture to be referred to, and controls the adaptive filtering operation not to be performed when the image data is a B-picture not to be referred to in the image data containing hierarchical B-pictures.

(7) The image processing device of any of (1) through (6), wherein

the image data is slice data, and

the filter control unit controls the adaptive filtering operation for the image data in accordance with a type of the slice.

(8) The image processing device of (7), wherein the filter control unit controls the adaptive filtering operation to be performed when the image data is an I-slice, and controls the adaptive filtering operation not to be performed when the image data is a P-slice and a B-slice.

(9) The image processing device of (7), wherein the filter control unit controls the adaptive filtering operation to be performed when the image data is an I-slice or a P-slice, and controls the adaptive filtering operation not to be performed when the image data is a B-picture.

(10) The image processing device of (7), wherein the filter control unit controls the adaptive filtering operation to be performed when the image data is an I-slice and a P-slice in image data containing hierarchical B-slices, or a B-slice to be referred to, and controls the adaptive filtering operation not to be performed when the image data is a B-slice not to be referred to in the image data containing hierarchical B-pictures.

(11) The image processing device of any of (1) through (10), further including

an encoding unit that encodes the image data subjected to the adaptive filtering operation,

wherein the encoding unit encodes a filter coefficient of the adaptive filtering operation and flag information indicating whether to perform the adaptive filtering operation, and adds the resultant data to the encoded data of the image data.

(12) The image processing device of any of (1) through (11), wherein

the filter control unit controls a tap length of a filter coefficient of the adaptive filtering operation, in accordance with whether the image data is to be referred to by other image data, and

the filtering operation unit performs the adaptive filtering operation on the image data, using the filter coefficient having the tap length controlled by the filter control unit.

(13) The image processing device of (12), wherein,

when the image data being subjected to the adaptive filtering operation is to be referred to by the other image data in an operation to encode the image data, the filter control unit performs control to increase the tap length, and

when the image data being subjected to the adaptive filtering operation is not to be referred to by the other image data in the operation to encode the image data, the filter control unit performs control to shorten the tap length.

(14) An image processing method that includes:

controlling an adaptive filtering operation to be performed on image data, in accordance with whether the image data is to be referred to by other image data, the control being performed by a filter control unit of an image processing device; and

performing the adaptive filtering operation on the image data in a motion compensation loop, the adaptive filtering operation being performed by a filtering operation unit of the image processing device.

### REFERENCE SIGNS LIST

500 Image encoding device, 501 Filter control unit, 502 Adaptive loop filter, 511 ON/OFF unit, 512 Filter coefficient calculation unit, 513 Filtering unit, 601 Filter control unit, 602 Adaptive loop filter, 611 Tap length setting unit, 612 Filter coefficient calculation unit, 621 Zero coefficient setting unit

1. An image processing device comprising:
a filter control unit configured to control an adaptive filtering operation to be performed on image data, in accordance with whether the image data is to be referred to by other image data; and
a filtering operation unit configured to perform the adaptive filtering operation on the image data under the control of the filter control unit in a motion compensation loop.

2. The image processing device according to claim 1, wherein,
when the image data being subjected to the adaptive filtering operation is to be referred to by the other image data in an operation to encode the image data, the filter control unit controls the adaptive filtering operation to be performed, and
when the image data being subjected to the adaptive filtering operation is not to be referred to by the other image data in the operation to encode the image data, the filter control unit controls the adaptive filtering operation not to be performed.

3. The image processing device according to claim 1, wherein
the image data is picture data, and
the filter control unit controls the adaptive filtering operation for the image data in accordance with a type of the picture.

4. The image processing device according to claim 3, wherein the filter control unit controls the adaptive filtering operation to be performed when the image data is an I-picture, and controls the adaptive filtering operation not to be performed when the image data is a P-picture and a B-picture.

5. The image processing device according to claim 3, wherein the filter control unit controls the adaptive filtering operation to be performed when the image data is an I-picture or a P-picture, and controls the adaptive filtering operation not to be performed when the image data is a B-picture.

6. The image processing device according to claim 3, wherein the filter control unit controls the adaptive filtering operation to be performed when the image data is an I-picture and a P-picture in image data containing hierarchical B-pictures, or a B-picture to be referred to, and controls the adaptive filtering operation not to be performed when the image data is a B-picture not to be referred to in the image data containing hierarchical B-pictures.

7. The image processing device according to claim 1, wherein
the image data is slice data, and
the filter control unit controls the adaptive filtering operation for the image data in accordance with a type of the slice.

8. The image processing device according to claim 7, wherein the filter control unit controls the adaptive filtering operation to be performed when the image data is an I-slice, and controls the adaptive filtering operation not to be performed when the image data is a P-slice and a B-slice.

9. The image processing device according to claim 7, wherein the filter control unit controls the adaptive filtering operation to be performed when the image data is an I-slice or a P-slice, and controls the adaptive filtering operation not to be performed when the image data is a B-picture.

10. The image processing device according to claim 7, wherein the filter control unit controls the adaptive filtering operation to be performed when the image data is an I-slice and a P-slice in image data containing hierarchical B-slices, or a B-slice to be referred to, and controls the adaptive filtering operation not to be performed when the image data is a B-slice not to be referred to in the image data containing hierarchical B-pictures.

11. The image processing device according to claim 1, further comprising
an encoding unit configured to encode the image data subjected to the adaptive filtering operation,
wherein the encoding unit encodes a filter coefficient of the adaptive filtering operation and flag information indicating whether to perform the adaptive filtering operation, and adds the resultant data to the encoded data of the image data.

12. The image processing device according to claim 1, wherein
the filter control unit controls a tap length of a filter coefficient of the adaptive filtering operation, in accordance with whether the image data is to be referred to by other image data, and
the filtering operation unit performs the adaptive filtering operation on the image data, using the filter coefficient having the tap length controlled by the filter control unit.

13. The image processing device according to claim 12, wherein,
when the image data being subjected to the adaptive filtering operation is to be referred to by the other image data in an operation to encode the image data, the filter control unit performs control to increase the tap length, and
when the image data being subjected to the adaptive filtering operation is not to be referred to by the other image data in the operation to encode the image data, the filter control unit performs control to shorten the tap length.

14. An image processing method comprising:
controlling an adaptive filtering operation to be performed on image data, in accordance with whether the image data is to be referred to by other image data, the control being performed by a filter control unit of an image processing device; and
performing the adaptive filtering operation on the image data in a motion compensation loop, the adaptive filtering operation being performed by a filtering operation unit of the image processing device.
